(19) United States
(12) Patent Application Publication
(10) Pub. No.: US 2009/0220645 A1
(43) Pub. Date: Sep. 3, 2009

(54) Quality Enhancement of Coffee Beans by Acid and Enzyme Treatment

(76) Inventors: Luis Federico Martinez, Jacksonville, FL (US); Murat Omer Balaban, Gainesville, FL (US)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/392,757

(22) Filed: Feb. 25, 2009

Related U.S. Application Data
(60) Provisional application No. 61/067,141, filed on Feb. 25, 2008.

(51) Int. Cl. A23F 5/02

(52) U.S. Cl. 426/45

(57) ABSTRACT

The subject invention provides methods for treating unroasted or green coffee beans to improve their quality of flavor to the palate, including reduced bitterness, better tasting, and improved aroma. In one embodiment, the invention pertains to the treatment of either green and un-dried, or green and dried, coffee beans with enzymes in a pH adjusted environment. According to the subject invention, the enzymes to be used, the pH of the treatment medium, and the times of treatment are parameters that are optimized based on different desired flavor and/or aroma outcomes.

### CROSS-REFERENCE TO RELATED APPLICATION(S)

The present application claims the benefit of U.S. Application Ser. No. 61/067,141, filed Feb. 25, 2008, which is hereby incorporated by reference herein in its entirety, including any figures, tables, or drawings.

### GOVERNMENT SUPPORT

The subject invention was made with government support under a research project supported by USDA/CSREES, Grant Number 2006-34135-17614. Accordingly, the U.S. Government has rights in this invention.

### BACKGROUND OF INVENTION

Coffee is one of the most consumed beverages in the world, and a world-wide trade commodity. One of the main characteristics of quality coffee is good organoleptic properties, which depend on the species, and on the processing steps involved. To maintain a high quality coffee product, special attention needs to be put on the following steps: selecting the coffee plant, harvesting the beans properly for each processing method, processing the beans, drying, hulling, roasting the beans, grinding and cupping.

In the typical process for making roasted and ground coffee, ripe berries (referred to as “cherries”) are de-pulped, which is the removal of the outer red husk, leaving the green coffee beans, which are still covered with a mucilage layer. De-pulping is typically done on the same day as harvesting to reduce or eliminate the effects of fermentation of the beans. There are a variety of techniques for removing the mucilage covering, including water soaking, drying, or mechanical friction. Each method imparts different qualities to the end coffee product.

The completely cleaned beans are often dried so as to contain standardized moisture content, prior to roasting. Green beans have a humidity of approximately 70% while mature cherries range from 35% to 50%, and dried cherries range from 16% to 30%. However, it has been shown that standardization can reach 11% moisture content (Franca, A. S., Mendonca, J. C. F., Oliveira, S. D. 2005. Composition of green and roasted coffees of different cup qualities. Lwt-Food Sci and Tech. 38 (7):709-15), which is also the recommended moisture level for coffee storage to prevent the development of musty, earthy and fermented flavors (Bee, S., Brando, C. H. J., Brumen, G., Carvalhaes, N., Kolling-Speer, I., Speer, K., Suggi Liverani, F., Texeira, A. A., Thomaziello. R. A., Viani, R., Vitzhum, O. G. 2005. The Raw Bean. In: Illy and Vianni, eds. Espresso Coffee: The science of quality. 2^{nd} Edition. London, UK. Elsevier Academic Press. p. 87-178). After drying, it is important to clean the dried beans either by suctioning the impurities or by air-flotation of coffee to separate weight differences of beans with impurities or rocks (Bee, 2005, supra). After drying, the beans are sorted by shape. The round beans will be hulled and roasted for commercial use, while the elongated ones will be used for nursery purposes.

Roasting is one of the most important steps in coffee processing. It applies heat to the green beans until they reach the proper color and smell. Roasting involves many different physical and chemical reactions that will determine the final coffee cup quality. During roasting it is very important to reach the correct temperatures at the right moment, and then stop the process when the aroma has fully developed and the color of the coffee is homogenous throughout the bean (Bonnlander, B., Eggers, R., Engelhardt, U. H., Maier, H. G. 2005. The Raw Bean. In: Illy and Vianni, eds. Espresso Coffee: The science of quality. 2^{nd} Edition. London, UK. Elsevier Academic Press. p. 179-214).

During roasting, the inner structure of the beans change, swelling occurs, and many other endothermic and exothermic reactions take place. The outer heat transport is by convection and conduction; the inner heat transport is done by conduction. Transport of water vapor, carbon dioxide and volatiles take place with an increase in temperature. Inside the bean, temperature starts rising soon after the local temperature has reached the evaporation temperature of the beans moisture, water vaporization occurs, dry mass loss, and changes in material properties occur (Bonnlander, 2005, supra).

The final flavor and aroma is a result of a combination of thousands of chemical compounds produced through several mechanisms like: Maillard browning, Strecker degradation, degradation of sugars and lipids, etc. (Franca, 2005, supra. Bonnlander, 2005, supra).

The time-temperature combination and type of process used will directly influence all the reactions and changes that take place, producing many different outcomes with different attributes, cup qualities and prices.

A number of methods have been used for treating coffee beans to improve the taste or otherwise affect the coffee. For example, in U.S. Pat. No. 2,119,329 to Heuser issued May 31, 1938, Heuser states that coffee having a richer flavor can be prepared by adding a small amount of oxidizing agent to the green coffee beans. About 0.25% by weight of the coffee of sodium hypochlorite can be added, usually by spraying the beans with an aqueous solution of the hypochlorite.

U.S. Pat. No. 1,640,648 to Cross, issued Aug. 30, 1927, discloses a process for decaffeination in which green coffee beans are first treated by an alkaline agent to convert the caffeine to an alkaloidal state, and the beans are subsequently roasted and decaffeinated in a single step.

In U.S. Pat. No. 312,516 to Schilling, issued Feb. 17, 1885, Schilling states that the full flavor and strength of coffee is brought out by coating the roasted beans with an alkaline salt, for instance bicarbonate of soda or borax. The alkaline salt is dissolved in water and sprayed onto beans still hot from roasting. The beans are subsequently ground.

U.S. Pat. No. 1,822,227 to Lendrich, et al., issued Sep. 8, 1931, discloses a process for making a better tasting coffee by decomposing the chlorogenic acid in coffee beans. The process involves treating green coffee beans with a heated solution of sodium hydroxide, potassium hydroxide, and mineral acid. The beans are subsequently neutralized before roasting.

Lastly, U.S. Pat. No. 3,644,122 to Yeransian, issued Feb. 22, 1972, discloses a process in which ground, roasted coffee or spent coffee grounds are treated with an alkaline material to provide coffee extract said to have increased yield and improved color.

Unfortunately, all of the above-referenced methods for improving coffee flavor and aroma do not provide coffee that has the richness and flavor of the variety known as “Kopi Luwak.” Kopi Luwak (or Civet coffee) is the most exotic and expensive coffee known, with a price range from $600 to $1200/kg. “Kopi” is the Indonesian word for coffee. It is mainly produced on the islands of Sumatra, Java, and Sulawesi in the Indonesian Archipelago, in the Philippines, and coffee estates of southern India. Even with all of these locations, the annual production is only about 150 kg. The reason is the unique harvesting technique. Ripe coffee berries are eaten by a marsupial called a Luwak or Asian Palm Civet (Paradoxurus hermaphroditus). These animals gorge on the ripe berries, which pass through the animals digestive tract and the partially-digested beans are excreted by the animal. These excreted beans when found are “harvested” for sale. The partially-digested beans are cleaned and then roasted to produce the highly sought-after Kopi Luwak. Unfortunately, breeding and raising civets is a very expensive and time consuming method for producing coffee.

The only published scientific literature on Kopi Luwak to date is by Marcone (Marcone, N. F. 2004. Composition and properties of Indonesian palm civet coffee (Kopi Luwak) and Ethiopian civet coffee. Food Res. Int. 37 (9): 901-9 12), which reported on various physicochemical properties of Palm Civet coffee (Kopi Luwak) and its comparison to African civet coffee. He found major physical differences between them that include color differences, where Kopi Luwak was found to be higher in red color hue and was overall darker than control beans. Scanning electron microscopy revealed that all Palm Civet beans possessed surface micro-pitting caused by the action of gastric juices and digestive enzymes during digestion. Large deformation mechanical rheology testing revealed that Kopi Luwak coffee beans were harder and more brittle than their controls indicating that digestive juices were entering into the beans and modifying the micro-structural properties. SDS-PAGE electrophoresis also showed a difference by revealing that proteolytic enzymes were penetrating into Kopi Luwak beans and causing substantial breakdown of storage proteins. Doing a complete proximate analysis, Kopi Luwak beans were found to be lower in total proteins, which means that proteins were partially broken down and leached out during the digestion process inside the animals' gastrointestinal tract. Since proteins are responsible for much of the flavor, particularly bitterness, it is clear that the lower protein content of Kopi Luwak is one reason for a less bitter coffee. Also after roasting, it was noted that there were significant differences in the flavor profile of the Kopi Luwak vs. the controls when analyzed by an electronic nose for volatile aroma compounds.

Accordingly, understanding of the chemical and physical principles behind the transformation of the beans through the Luwak digestion can provide a process for treating coffee beans to produce Kopi Luwak, or similar quality coffees, without the Luwak or Asian Palm Civet. Such a method would provide a more controlled, consistent, and economical way to obtain high quality coffee with a unique flavor, aroma, texture, body, smoothness and richness.

### BRIEF SUMMARY

The subject invention provides methods for treating green (raw) coffee beans to improve their quality of flavor to the palate, including reduced bitterness, better taste, and improved aroma. Specifically, the present invention provides processes for making a better-tasting coffee, in particular a coffee having a richer taste, similar to that of Kopi Luwak.

In one embodiment, the invention pertains to the treatment of green (un-dried or dried) coffee beans with enzymes in a pH adjusted environment ex vivo. According to the subject invention, the enzymes to be used, the pH of the treatment medium, and the times of treatment are parameters that are optimized based on different desired flavor and/or aroma outcomes.

Without being limited to any theory, it appears that exposing green coffee beans to certain enzymes partially digests proteins and/or carbohydrates in the beans. The resultant coffee beans, after roasting, have better flavor quality and less bitterness, comparable to that of Kopi Luwak.

In one embodiment of the subject invention, a treatment regimen has been established whereby the coffee is treated with pepsin and HCl. After treatment, the treated coffee and controls are roasted at temperatures tip to 228° C. for 18 minutes. Taste panels showed that treated samples were significantly less bitter than controls.

In one embodiment of the subject invention, acids and enzymes are used to treat coffee beans, which enhances the aroma and flavor, and reduces the bitterness of coffee. The changes imparted to the beans can be quantified using GC-O, GC-MS for aroma compounds, and HPLC for chlorogenic and other acids, to optimize the acid and enzyme treatment combinations.

The methods of the subject invention can be used to consistently enhance the quality of coffee, whereby the concentration of undesirable flavors is reduced while the concentration of good coffee flavors is retained and/or enhanced, resulting in a richer-tasting coffee. In one embodiment, the subject invention provides a roasted and ground coffee product having a better aroma, and/or one having a less unpleasant aroma.

The methods are applicable to both scientific and industrial applications. Thus, the processes of the subject invention can produce coffee of the highest quality and can be scaled for commercial applications. Such improvements to coffee products can aid the development and enhancement of value-added agriculture in the US, as well as the agricultural sector of different countries by the production of a commodity of higher value.

### BRIEF DESCRIPTION OF DRAWINGS

FIGS. 1A and 1B are reports obtained from coffee beans treated according one embodiment of the subject invention by a gas chromatograph-olfactometry with an FID detector (FIG. 1A) and without an FID detector (FIG. 1B).

FIGS. 2A and 2B are reports obtained from control (untreated) coffee beans by a gas chromatograph-olfactometry with an FID detector (FIG. 2A) and without an FID detector (FIG. 2B).

FIGS. 3A, 3B, and 3C are color images of the control panel of a gas fired coffee roaster (Ambex Roasters Inc., model YM15, Clearwater, Fla.) utilized for the bean roasting in establishing a roasting standardization for coffee beans. The roaster was equipped with independent roaster and cooling systems and a real time data acquisition system with thermocouples inside the roaster allowed close monitoring and accurate roasting profile control. FIGS. 3A, 3B and 3C represent different coffee batches A, B, and C, respectively. It can be seen that the roasting profile used for each batch was the same.

FIGS. 4A and 4B are color images that show the roasting profiles for temperature vs. time for three 5 lb. batches of treated (FIG. 4A) and control (FIG. 4B) coffee beans. It can be seen in the illustrations that the roasting profiles for each batch were the same.

FIG. 5 is a color photograph of a sample holder designed for electronic nose analysis, according to one embodiment of the subject invention.

FIGS. 6A and 6B are scanning electron microscope images of a control (raw) coffee bean at 100× magnification (FIG. 6A) and treated (raw) coffee bean at 100× magnification (FIG. 6B).

FIG. 7 is a color plot of viscosity vs. time for treated and control coffee samples.

FIGS. 8A and 8B are scanning electron microscope images of a treated bean at 500× (FIG. 8A) and at 3000× (FIG. 8B).

FIG. 9 is a scanning electron microscope image of a control (raw) coffee bean at 500×.

FIG. 10 shows the evaluation of color primitives conducted on electron microscope images of treated and control samples of coffee beans (threshold=35).

FIG. 11 shows the evaluation results of texture primitives conducted on the electron microscope images of treated and control samples of coffee beans (threshold=35).

FIG. 12 is a color image that shows the evaluation results of contour analysis conducted on electron microscope images of treated and control samples of coffee beans (L* contour >40).

FIG. 13 graphs the results obtained from a Cyranose®320 (Smiths Detection, New Jersey, N.J.) electronic nose. Analysis was conducted on a treated batch of coffee, the three batches A, B, and C used for preliminary tests (See FIGS. 3A, 3B, and 3C), as well as a control batch of coffee. FIG. 13 shows the results of discriminant function analysis performed on twelve sensors (5, 6, 9, 11, 17, 18, 20, 23, 26, 28, 29, and 31) that showed the highest ΔR/R values. (ΔR/R is defined as: the maximum difference from the baseline to the highest resistance point of the sample exposure step within the sniff) obtained from coffee Batch A.

FIG. 14 graphs the results obtained from a Cyranose® 320 (Smiths Detection, New Jersey, N.J.) electronic nose. Analysis was conducted on a treated batch of coffee, the three batches A, B, and C used for preliminary tests (See FIGS. 3A, 3B, and 3C), as well as a control batch of coffee. FIG. 14 shows the results of discriminant function analysis performed on twelve sensors (5, 6, 9, 11, 17, 18, 20, 23, 26, 28, 29, and 31) that showed the highest R/R values obtained from a control coffee sample (Run 1).

FIG. 15 graphs the results obtained from a Cyranose® 320 (Smiths Detection. New Jersey, N.J.) electronic nose. Analysis was conducted on a treated batch of coffee, the three batches A, B, and C used for preliminary tests (See FIGS. 3A, 3B, and 3C), as well as a control batch of coffee. FIG. 15 show the results of discriminant function analysis performed on twelve sensors (5, 6, 9, 11, 17, 18, 20, 23, 26, 28, 29, and 31) that showed the highest R/R values obtained from a treated coffee sample (Run 1).

FIG. 16 is a table that shows the squared Mahalanobis distances calculated by Statistica 7.0 and illustrates how distant each sample group is from the other.

FIG. 17A Discriminant function analysis summary for all sensors and all samples.

FIG. 17B provides classification functions; grouping: Type (all sensors and all samples)

FIGS. 18A and 18B show the unstandardized canonical scores as a discriminant function analysis plot (FIG. 18A) of the unstandardized canonical scores (FIG. 18B), which were obtained for all groups by the electronic nose showing a clear separation of the treated bean from the controls.

FIGS. 19A and 19B are color photographs that show a machine vision image of control coffee beans. Three Labsphere red, green and blue true color standards were used for color calibration. Before treatments (FIG. 19A), the green coffee beans had a typical olive color. This color changed for the samples that were treated, from olive to an olive brown or brown (FIG. 19B).

FIGS. 20A and 20B are color photographs that show a machine vision image of roasted coffee beans. Three Labsphere red, green and blue true color standards were used for color calibration. FIG. 20A shows an image of the roasted control coffee beans with the color standards. FIG. 20B shows an image of roasted treated coffee beans with the color standards.

FIGS. 21A and 21B are color photographs that show a machine vision image of roasted coffee beans. Three labsphere red, green, blue true color standard were used for color calibration. FIG. 21A shows an image of ground control coffee beans with color standards. FIG. 21B shows an image of ground treated coffee beans with color standards.

### DETAILED DISCLOSURE

The subject invention provides methods for treating unroasted or green coffee beans to improve their quality of flavor to the palate, including reduced bitterness, better taste, and/or improved aroma. Specifically, the present invention provides processes for making a better-tasting coffee, in particular a coffee having a richer taste, similar or comparable to that obtained from Kopi Luwak or civet coffee beans.

The subject process comprises treating coffee beans with a solution containing an enzyme in a pH adjusted environment ex vivo. Ex vivo, as understood by the skilled artisan, is an artificial environment outside a living organism. The enzymes to be used, the pH of the treatment medium, and the time of treatment are parameters that can be optimized based on different desired outcomes.

### Treatment of Coffee Beans:

According to the subject invention, de-pulped beans that are still in mucilage are subjected to an acid bath.

Preferably, the treatment environment is an acidic pH; more preferably at a pH of about 1 to about 5. Even more preferably, the treatment environment is at a pH of about 1.5 to about 2.0.

In one embodiment, the mucilage-covered green beans are submerged in a water and hydrochloric acid bath adjusted to a pH of approximately 1.5 to approximately 2.0. In an exemplified embodiment, the green beans are submerged with a water and hydrochloric acid bath adjusted to a pH of about 1.7-1.8. In certain embodiments, bean mucilage is removed due to processing of the cherries before treatments; bean parchment can also be removed during normal coffee processing.

According to the subject invention, green coffee beans are treated with a solution that contains, as its active component, certain enzymes. The enzymes that can be used in accordance with the subject invention include enzymes selected from the group consisting of: amylases, glucosidases, mannosidases, dextranases, proteases, exoproteases, endoproteases, phosphatases, phytases, phospholipases, lipases and nucleases. Preferred enzymes are proteolytic (proteases) and/or amylolytic (amylases) enzymes. In a specific embodiment, the enzyme pepsin is used. In an alternative embodiment, two or more enzymes are utilized in the treatment.

In one embodiment, after adjustment of the pH as described above, enzymes can be added to the water bath. In one embodiment, pepsin enzyme from porcine stomach mucosa can be added at approximately 8.0×10³ to 13.0×10³ units per kg of beans. More preferably, porcine pepsin enzyme is added at approximately 11×10³ units per kg of coffee beans. In a specific embodiment, porcine pepsin enzyme is added at approximately 2.5×10⁴ units per 2.27 kg of beans. Preferably, Porcine Pepsin enzyme is added at approximately 8 grams to 13 grams per kg of coffee beans; more preferably about 11 grams (1:10,000=1 gram of powder=10,000 units of pepsin enzyme) per kg of coffee beans. Pepsin from different sources other than porcine can also be used in accordance with the subject invention.

According to the subject invention, the coffee beans can be contacted with the enzyme(s) in a pH environment from about 90 minutes to 24 hours. Preferably, treatment time is from about 10 hours to 14 hours. Most preferably, this treatment time is about 12 hours. During this time, the mucilage is loosened from the bean and can be easily removed during the washing process.

According to the subject invention, during the period in which the coffee beans are subjected to an acidic solution comprising the enzyme(s) ex vivo, the solution can be heated to about 30° C. to about 45° C., preferably about 35° C. to about 40° C. and even more preferably from about 35° C. to 37° C.

### Types and Grades of Coffee Beans:

The unroasted green coffee beans can be dried prior to or after treatment with an enzyme in a pH adjusted environment. In addition, following exposure to an enzyme in a pH adjusted environment, the coffee beans can be roasted to their final roast color and ground in a conventional manner to provide roast and ground coffee products having desired aroma and flavor characteristics.

Coffee beans useful in the present invention can be either of a single type or grade of bean or can be formed from blends of various bean types or grades, and can be caffeinated or decaffeinated. For example, high grade coffees characterized as having “excellent body,” “fragrant,” “aromatic” and occasionally “chocolatey” can be used in the subject invention. Typical high quality coffees that can be used in the subject invention include, but are not limited to, Arabicas, Colombians, Mexicans, and other “hard beans” such as Costa Rica, Kenyas A and B, and strictly hard bean Guatemalans.

Coffees useful in the present invention can also include intermediate grade coffees including, but not limited to Brazilian coffees such as Santos and Paranas, African Naturals, and Suldeminas, which are characterized as having bland, neutral flavor and aroma, lacking in aromatic and high notes, and are generally thought to be sweet and non-offensive.

Other coffees useful in the present invention can also include low grade coffees. Suitable low grade coffees include Robustas, or low acidity natural Arabicas. These low grade coffees are generally described as having rubbery flavor notes and produce brews with strong distinctive natural flavor characteristics often noted as bitter.

### Roasting Coffee Beans:

Prior to roasting, the coffee beans can be partially pre-dried to a moisture content of from about 10% to about 40%, preferably from about 11% to about 30%. Partial pre-drying can be desirable where a higher proportion of moderate to low acidity-type coffees are used make the moisture more uniform and thus less susceptible to tipping and burning. Partial pre-drying can be carried out according to any of the methods disclosed in U.S. Pat. No. 5,160,757 (Kirkpatrick et al), or U.S. Pat. No. 5,322,703 (Jensen et al), both of which are incorporated herein by reference in their entirety. In an alternative embodiment, coffee beans are not pre-dried prior to roasting.

The treated coffee beans of the invention are carefully roasted under conditions that avoid tipping and burning of the beans. As used herein, the terms “tipping” and “burning” relate to the charring of the ends and outer edges of a bean during roasting. Tipping and burning of beans results in a burnt flavor in the resulting brewed beverage. Tipping and burning can be avoided by the combination of using high quality beans with minimal defects, roasting similar sizes and types together, uniform heat transfer (preferably convective), and controlling the heat input rate throughout the roast to prevent the edges of the beans from burning.

Any of a variety of roasting methods known to the coffee art can be used to roast the treated coffee beans. In the normal operation of preparing conventional roast and ground coffee, coffee beans are roasted in a hot gas medium, either in a batch process or a continuous process. The roasting procedure can involve static bed roasting as well as fluidized bed roasting. Typical roasting equipment and methods for roasting coffee beans are disclosed, for example, in Coffee, Vol 2: Technology, at pages 89-97, Clarke & Macrae (Eds.) Elsevier Applied Science. New York (1987), which is incorporated herein by reference. Batch coffee roasters that can be utilized with the methods of the subject invention include horizontal drum roasters and fluidized bed roasters. For example, the Jetzone® roaster manufactured by Wolverine (U.S.), the Probat® roaster manufactured by Probat-Werke (Germany), the Burns System 90 roaster by Burns (Buffalo, N. Y.), the HYC roaster by Scolari Engineering (Italy), and the Neotec® RFB by Neotec (Germany), can be suitable for use with the subjection invention.

In further embodiments, there are several different modern roasting methods, known to those with skill in the art, that can be distinguished by type and characteristics (Bonnlander, 2005, supra) and can be applied to the coffee beans treated in accordance with the subject invention. These methods can include: rotating cylinder, bowl, fixed drum, fluidized bed, spouted bed and swirling bed.

Time, temperature and type of roasting technique can lead to a different degree of roast and characteristics, as also known to those with skill in the art. One company (Ambex Inc., Clearwater, Fla.) has been able to study, develop and patent a high quality roaster controlled by software with the capability of controlling the complete roasting time-temperature profile. This technology allows the roaster to control time-temperature combinations, plus additional parameters such as bean temperature, chamber temperature, ramp rate, pilot temperature, etc. The roast master can predict exactly how the roasting profile will behave for a specific type of coffee, also it can adjust the software to roast exactly the same way for each batch making the beans go through the first crack point (first bean expansion due to internal pressure becoming maximum), second crack point (second and final bean expansion due to internal pressure) and cooling at exactly the same time. Ambex Inc. claims that besides roasting at the same temperature and for the same time, there are many variations that can occur during roasting, which affects the quality of the roasted coffee and jeopardizes the possibility to have exactly the same cup quality from batch to batch. This roasting process and software is a method that allows the control of many processing parameters for a more even and optimized roast. One embodiment of the invention envisions using this equipment and process for roasting coffee beans that have been treated in accordance with the methods described herein.

### Changes Produced by Roasting:

Many physical and chemical transformations and reactions take place during the coffee roasting process. In addition to changes in color and appearance, the beans become more porous and several organic losses occur such as the destruction of carbohydrates, chlorogenic acid and trigonelline. The aroma content reaches a maximum at low to medium roasting. The pH increases with the increase in roasting levels.

One of the most important changes to occur during roasting are the levels of chlorogenic acids. Chlorogenic acids are the most important acids in green coffee; they occur at a level of 5-8% and are one of the major water soluble constituents of the bean (Moores, R. G., McDermott, D., Wood, T. R. 1948. Determination of chlorogenic Acid in Coffee. Central Laboratories, General Floods Corporation. Hoboken N.J., 1948)

Minerals with the exception of phosphoric acid do not change upon roasting. Alkaloids such as caffeine do not change upon roasting but a small part is lost by sublimation; others like trigonelline are partially decomposed.

Green coffee is known to contain approximately 300 volatiles (Flament. I., 2001, The volatile compounds identified in green coffee beans. In: Coffee flavor chemistry. Chichester: J. Wiley and Sons. p. 29-34; cited in Bonnlander. 2005, supra). The peasy and green smell characteristic of raw coffee changes into a pleasant aroma after roasting. To date over 1000 volatiles have been identified in roasted coffee (Lee, K., Shibamoto, T. 2002. Analysis of volatile components isolated from Hawaiian green coffee beans (Coffea Arabica L.). Flavour Fragr. J. 17: 349-351), of which the majority have been induced from the roasting process. Thus, roasting causes significant changes that affect the taste, aroma, and cup quality of the final coffee product.

### Cup Quality:

The cup quality can be characterized or measured organolepticly according to its acidity, aroma, and body. Cupping is a sensory method used to evaluate the flavor profile of coffee. According to the International Trade Centre (International Trade Centre “ITC”. 2002. Coffee, and exporter's guide. Product and marketing development. UNCTAD CNUCED, WTO OMC. Geneva; cited in Bee, 2005, supra), the coffee cup can be characterized by the following terms:

ACIDITY. A desirable flavor that is sharp and pleasing but not biting. Acidity in coffee represents smoothness and richness.

AROMA. Desirable smell in reference to caramel, nutty, chocolate, spicy, resinous, pyrolitic, flowery, lemon and herbal essences (Specialty Coffee Association of America cupping form (2002); cited in Ambex Inc. Roasting School cupping forms. See Appendix A).

BODY. Mouthfeel based on the consistency or an apparent viscosity of the coffee drink.

Price of coffee can be determined based on its cup quality but only to some extent. In most countries price is determined based on a ranking provided by the cuppers. In Kenya, the coffee is graded based on size and density, in Colombia coffee is graded based on altitude.

Cupping is a sensory method used to evaluate the flavor profile of coffee. Professional cuppers are valuable in the coffee industry; they evaluate the green and the roasted coffee. By cupping, differences between producing regions and processes can be determined; also cupping allows the detection of defects that will result in a low cup quality once roasted.

During cupping many important aspects need to be considered, like sample preparation, cupping room conditions and cupping evaluation parameters. For this reason, to ensure consistency in products, the same cupping protocol is used throughout the world ensuring that grading is done consistently and that trading is based on the same parameters.

Cupping and sensory evaluation is done based on several parameters. Fragrance/aroma is graded based on different smell impressions with descriptions such as flowery, herbal, fruity, nutty, caramel, vanilla, spicy, chocolate and earthy. Sweetness can be evaluated as lively, delicate, fine and natural. Flavor is evaluated as chocolate, caramel, fruit, herbal, flower, citrus, nutty, berry, deep, complex and balanced. Acidity is evaluated as delicate, moderate, intense, smooth, gentle, fruity, citrus, astringent and sharp. Aftertaste is evaluated as weak, moderate, unforgettable, long, round, clean, dirty and musty. Body is evaluated as round, delicate, light, medium, full, heavy, intense, creamy and rich. Besides these parameters, the final score is based on four more parameters which include balance, uniformity, clean cup and cupper perception (Summa Coffea Academy™ 2007. Cupping & Sensory Evaluation. Clearwater, Fla.)

### Grinding and Flaking Roasted Beans:

The roasted coffee beans can be ground using any conventional coffee grinder. Depending upon the specific particle size distribution desired in the final product of the present invention, the coffee fractions can be ground to the particle size distributions or “grind sizes” traditionally referred to as “regular,” “drip,” or “fine” grinds. Persons with skill in the art are familiar with and would be able to determine the correct grind size for the expected type of coffee preparation

Coffee products according to the present invention can also be flaked according to methods and techniques known to those with skill in the art.

### Cup Color and Brew Absorbance:

An important characteristic of coffee beverages prepared from roast and ground or flaked coffee products according to the present invention is cup color. A dark cup of coffee is the first thing that a coffee drinker typically looks for. The coffee drinker will initially look at the cup of coffee to visually judge its strength. If the cup is too clear and allows light to transmit through it, it is usually considered too weak. However, if the brew in the cup is too dark so that virtually no light can transmit through it, it is usually considered too strong.

Before ever tasting the coffee, the coffee drinker has thus judged in their mind as to what the strength will be, and by tasting it, confirms through taste what they have already visually seen. Therefore, an adequately strong cup of coffee must first visually look dark.

Traditionally, the darker the cup of coffee, the stronger it is. This observation is true of high grade coffees. Except for the formation of offensive flavors (burnt, rubbery, rioy), the darkness of the cup almost always correlates with the strength. Therefore, by measuring and controlling the cup darkness, one can not only predict the visual response to cup darkness, but can also somewhat predict its true strength (assume no offensive flavors).

To technically measure the darkness of the coffee brew, a machine vision system can be used to measure the colors of the green coffee beans and liquid brewed coffee, both treated and untreated. Darkness is denoted by a lower L* value and redness is denoted by a higher a* value. Coffee beverages prepared from roast and ground or flaked coffee products prepared according to the present invention have a much darker color than the untreated beans.

It is known that most of the flavors of the coffee are developed during roasting. The complex interaction between proteins, carbohydrates, and other constituents of the green (raw) coffee bean are governed by the temperature and time of roasting. Thus, the initial composition of the beans is critical. The subject invention modifies the composition of the green coffee beans by using enzymes to partially digest proteins and/or carbohydrates, so that after roasting the coffee has a better flavor quality, and less bitterness.

In order to quantify the changes that occur in coffee beans by the treatments of the subject invention, instrumental analysis of coffee beans was conducted. Surface analysis was performed using a regular light microscope. Controls, treated beans with and without the hull were evaluated. Beans treated without the hull showed many differences in texture, compared to beans treated with the hull and to a less extent controls. Cracks and apparent holes were detected on the beans treated without the hull, suggesting that the acids and enzymes used were penetrating the beans during the digestion process. There was a limitation to this test, since the coffee samples were opaque and the light transmission was impossible, an external lamp was used to illuminate the samples for analysis. Further analysis with a Field Emission Scanning Electron Microscope (SEM) was necessary to compare and establish differences in texture of the treated beans vs. untreated beans or controls.

Color analysis can be done with the use of computer or machine vision, which has been used for color analysis in the food industry for several years (Luzuriaga, D. A. 1999. Application of computer vision and electronic nose technologies for quality assessment of color and odor of shrimp and salmon [DPhil dissertation]. Gainesville, Fla.: University of Florida. Available from: University of Florida Library). Machine vision is a nondestructive process that can analyze every pixel of an image and account for color distribution (Balaban, 2005, supra). Many applications have been developed, and it is currently being used for many purposes in research studies and in the industry for quality control, food product development, etc.

### Electronic Nose:

The electronic nose is a relatively new tool that can be used for safety, quality or process monitoring, accomplishing in a few minutes procedures that may take days using other available analysis tools such as GC, GC-O, etc. (see, for example, Korel, F., Luzuriaga, D. A., Balaban, M. O. 2001. Objective quality assessment of raw tilapia (Oreochromis niloticus) fillets using electronic nose and machine vision. J. Food Sci. 66 (7): 1018-1024; Korel, F., Balaban, M. O. 2002a. Microbial and sensory assessment of milk with an electronic nose. J. Food Sci. 67 (2):758-764; and Korel, F., Balaban, M. O. 2002b. Uses of electronic nose in the food industry. Gida (Turkish). 28 (5): 505-511) which require preparatory measures and expertise in understanding the results, as opposed to this fast e-nose method. These analytical methods quantify individual compounds and not the overall impression of those compounds. The e-nose can be used as a complementary method to the analytical methods (Van Deventer, D., Mallikarjunan, P. 2002. Comparative performance analysis of three electronic nose systems using different sensor technologies in odor analysis of retained solvents on printed packaging. J. Food Sci. 67 (80):3 170-83).

An electronic nose simulates human olfactory process and consists of an array of chemical sensors and a pump. The sensors can be manufactured using conducting polymers, metal oxides, lipid layers, phthalocyanins, and piezoelectric materials (Korel, F., Balaban, M. O. 2002b. Uses of electronic nose in the food industry. Gida (Turkish). 28 (5): 505-511). The pump is used to pull a sample from the headspace of the material being analyzed and the sensors provide a set of measurements or resistances, which give a specific “fingerprint” of the volatiles present in the material at the time of the “sniff”. The e-nose is used in conjunction with a pattern-recognition algorithm, which allows recognition of different patterns of the training data set, which allows on-site detection capabilities without much hardware dependency.

### Sensory Analysis:

Sensory analysis or sensory evaluation is a scientific discipline that applies principles of experimental design and statistical analysis to the use of human senses (sight, smell, taste, touch and hearing) for the purpose of evaluating consumer products.

Sensory Analysis can be divided into three sections: Effective testing, affective testing, and perception. Effective testing is focused on obtaining objective facts about products. Affective testing or consumer testing is focused on obtaining a subjective evaluation or how well the products are likely to be accepted. Perception involves the use of biochemical and psychological theories relating to human sensations, to help understand and explain why certain characteristics are preferred over others (Sims, C. 2004. Sensory Analysis handouts. Quality Control Class. University of Florida. Gainesville, Fla.).

Discrimination methods (objective) answer whether any differences exist between two or more products. Descriptive methods (subjective) answer how products differ in specific sensory characteristics and provide quantification of these differences (Lawless, H. T., Heymann, H. 1998. Sensory evaluation of food: Principles and practices. Chapman and Hall. NY. p. 819; cited in Damar, S. 2006. Processing of coconut water with high pressure carbon dioxide technology. [DPhil dissertation]. Gainesville, Fla.: University of Florida. Available from: University of Florida Library). Examples of sensory analysis tests include triangle tests, duo-trio tests and paired comparison tests. (Sims. C. 2004. Sensory Analysis handouts. Quality Control Class. University of Florida. Gainesville, Fla.).

Following are examples that illustrate procedures for practicing the invention. These examples should not be construed as limiting. All percentages are by weight and all solvent mixture proportions are by volume unless otherwise noted.

### Example 1

### Roasting Standardization

### Preliminary Experiments

Coffee treatments: Approximately 45 Kg of coffee beans (also referred to herein as “cherries”) (Coffea Arabica L, Limani variety) were harvested at the University of Puerto Rico “Experimental Station” in Adjuntas, PR. They were hand picked at the ripe state (red color) maintaining the most color uniformity as possible as instructed to the workers. The cherries were then put in selection tables where they were cleaned of leaves and immature beans. This process was completed in approximately one hour, which prevented the harvested beans from starting to ferment. The cherries were then put into plastic containers. The cherries were then put in one 3785 cm³ Ziploc® bags and frozen for 24 hours at −40 degrees C. After 24 hours the frozen cherries were thawed using tap water and de-pulped using a custom made grape crusher. The beans covered by the mucilage were collected and put in a plastic container. The beans weighed 27 Kg showing a loss of approximately 40% pulp.

Approximately 9 Kg of de-pulped beans were used for the experiments. Beans were separated into two batches: 6.8 Kg for fermentation and 2.27 Kg for treatments. Both batches were covered with deionized water. Batch two was adjusted to pH 1.7 (pH 1.5-2.0 is optimum for pepsin activity) using hydrochloric acid (Sigma-Aldrich, St. Louis, Mo.), and 25 grams of Pepsin (1:10,000=1 gr. of powder=10,000 units of pepsin enzyme) from Porcine Stomach Mucosa (Sigma-Aldrich, St. Louis, Mo.) was added (11.01 grams per Kg) (Several enzyme concentrations were studied previously and the concentration that had the most effect on the surface of the beans were selected as optimum).

Both batches were maintained for 12 hours before cleaning. In batch one, the naturally occurring bacteria in the bean fermented the mucilage therefore cleaning the bean. In batch two the acids and enzymes used also removed the mucilage. Both batches were rinsed with water many times to remove the impurities, to remove the enzymes and wash the acids.

Batch one and two were dried using a commercial food dryer (Excalibur, Sacramento, Calif.) to reach 11-30% recommended moisture (Bee, 2005, supra; Tosello, A. 1946. Studies on the drying of agricultural products. Bragantia p. 39-107; Rigitano, A., Sousa, O. F., Fava, J. F. M. 1963. Coffee processing. In: C. A. Krug, ed, Agricultural practices and fertilization of coffee. Instituto Brasilero Potassa. Sao Paulo. p. 215-259) for approximately eleven hours at 35-45° C. Once dried, approximately 2.27 Kg of fermented beans were de-hulled by hand, and later treated by acid and enzymes as mentioned previously.

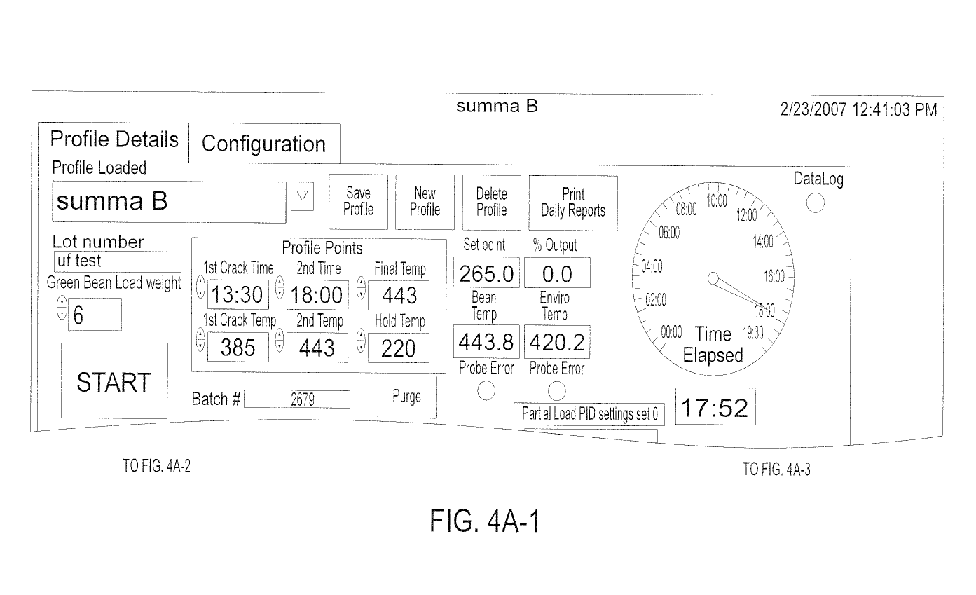

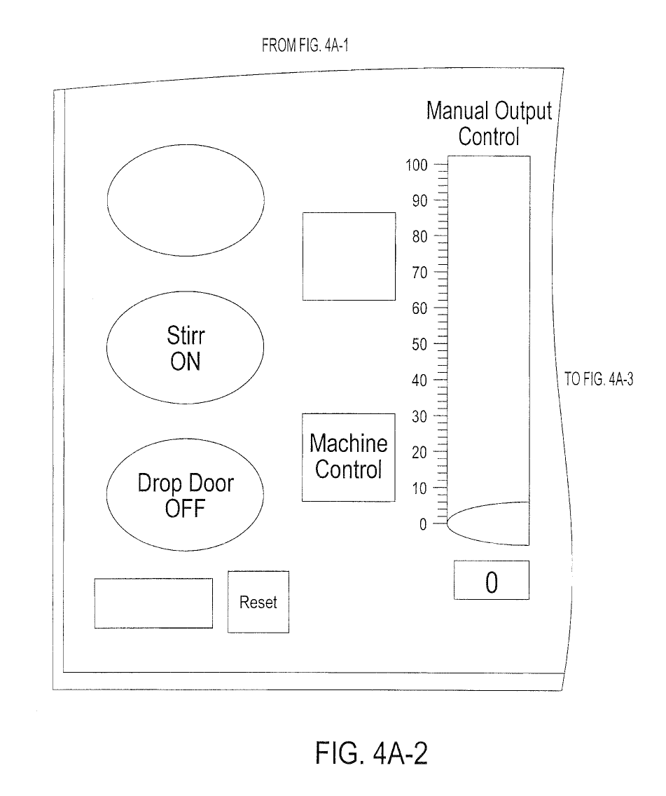

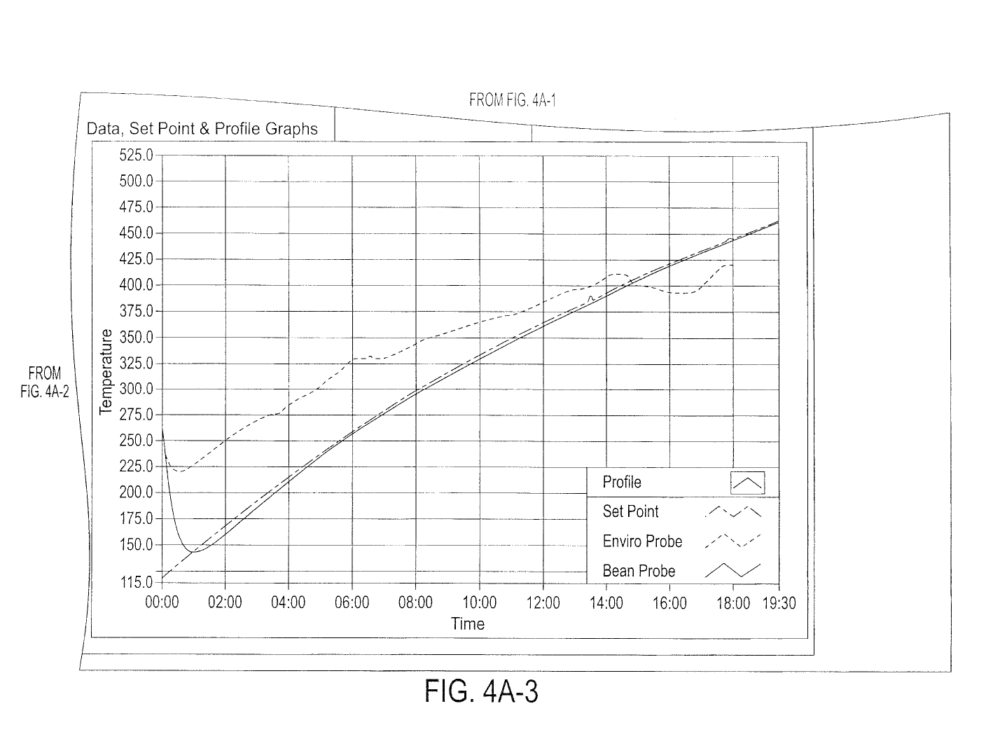

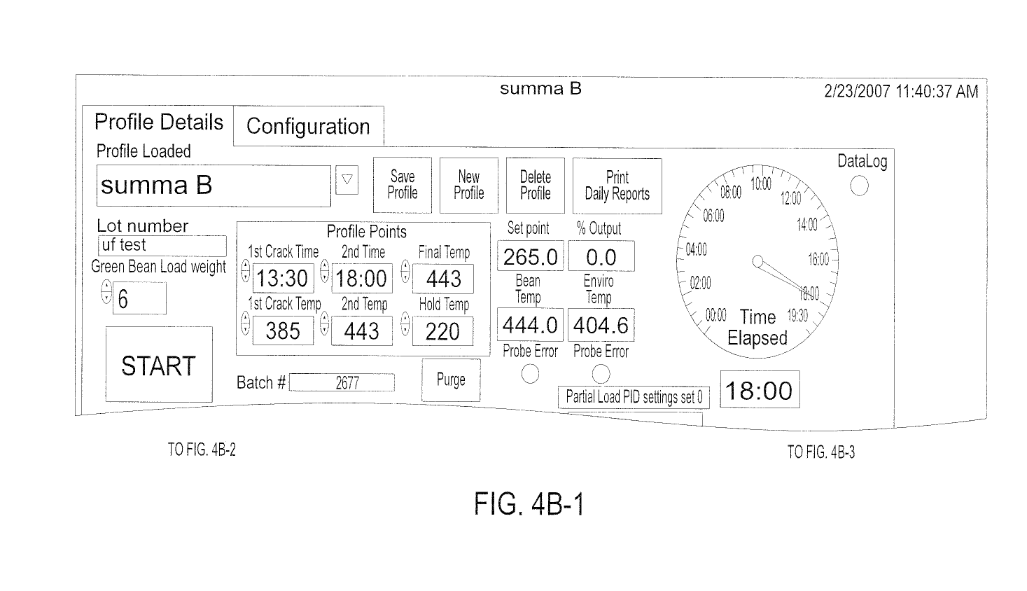

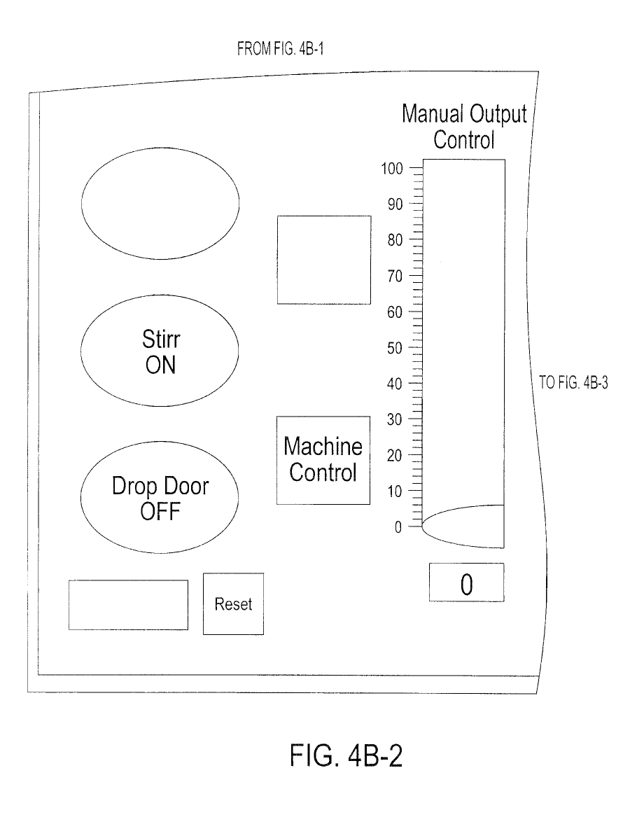

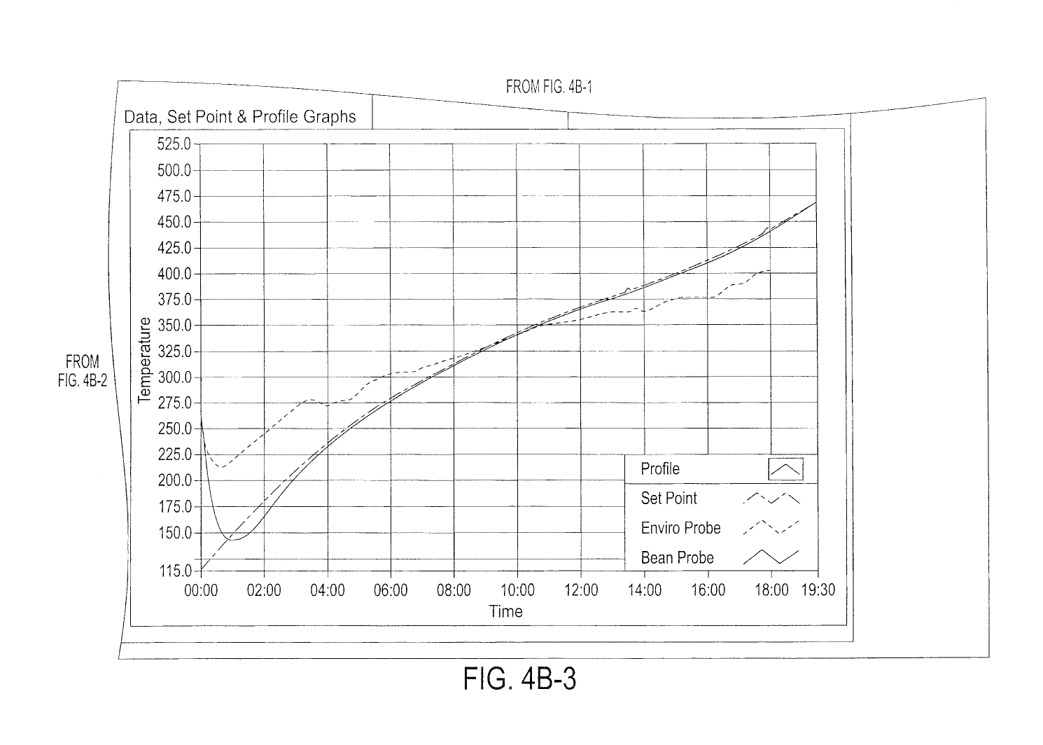

The beans were roasted using a gas fired coffee roaster (Ambex Roasters Inc. model YM15, Clearwater, Fla.). The roaster was equipped with independent roaster and cooling systems and a real time data acquisition system with thermocouples inside the roaster allowed close monitoring and accurate roasting profile control. The roasting profile used was the same as in FIGS. 4A and 4B.

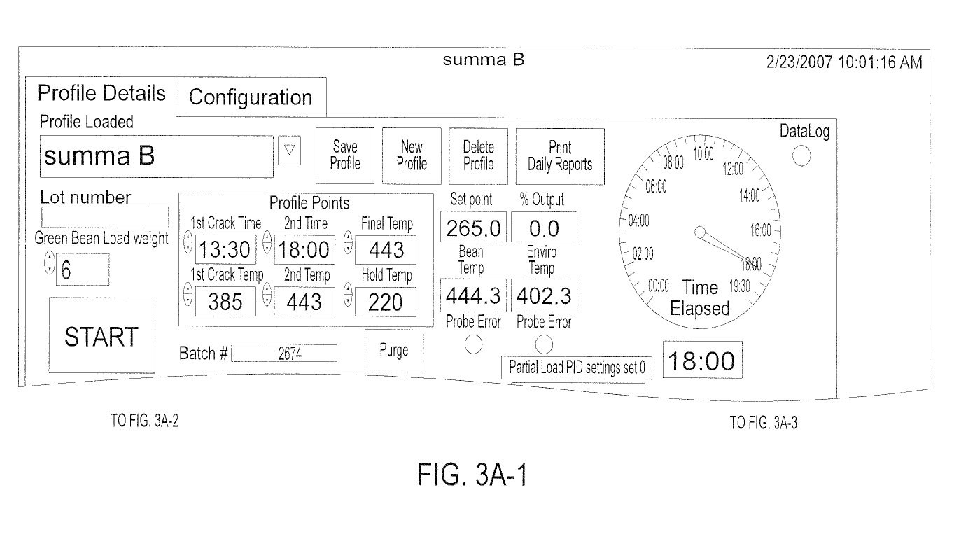

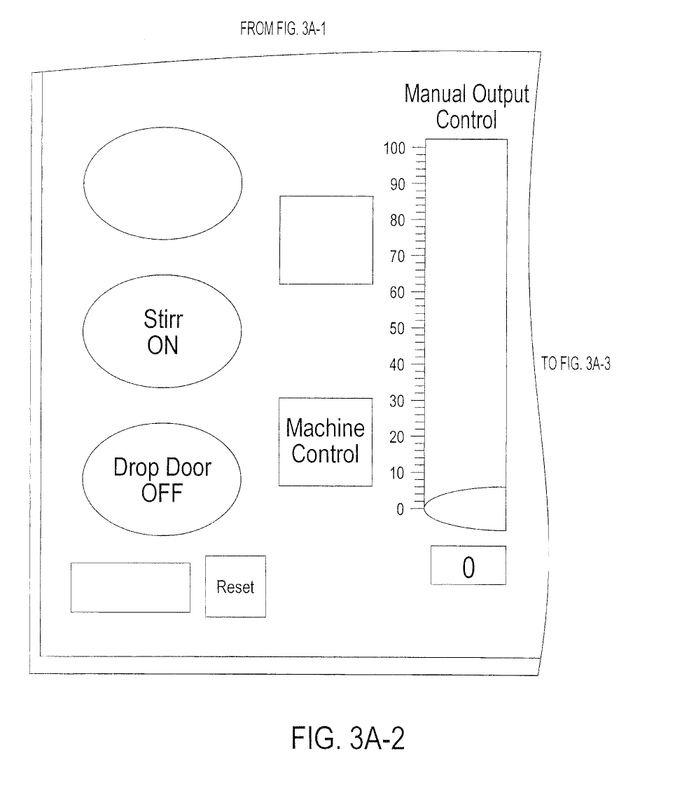

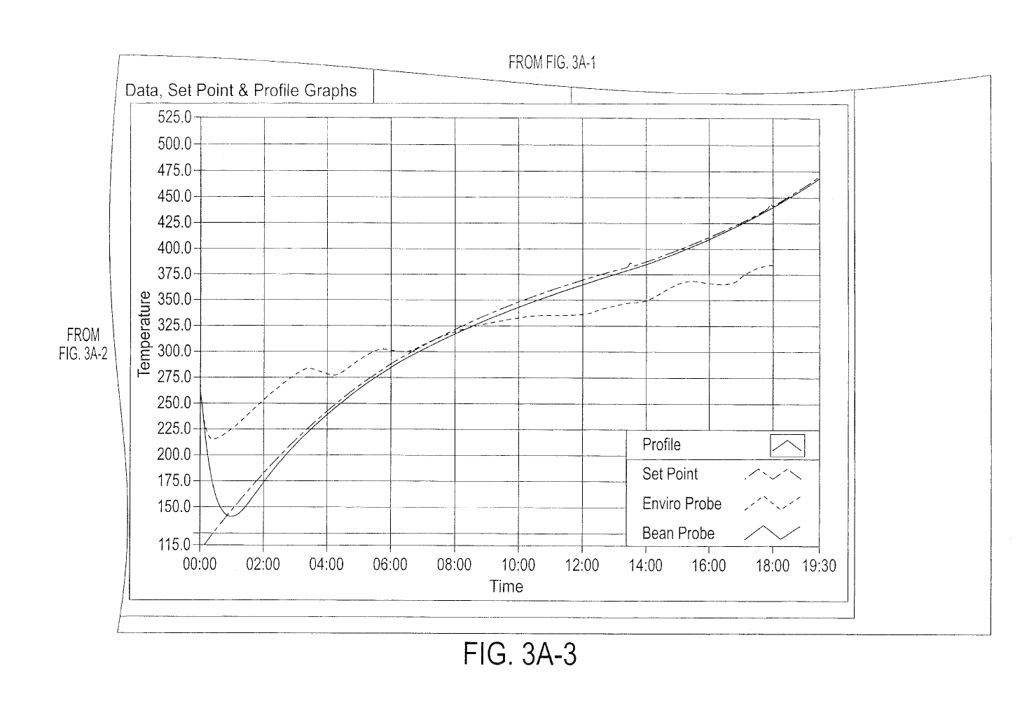

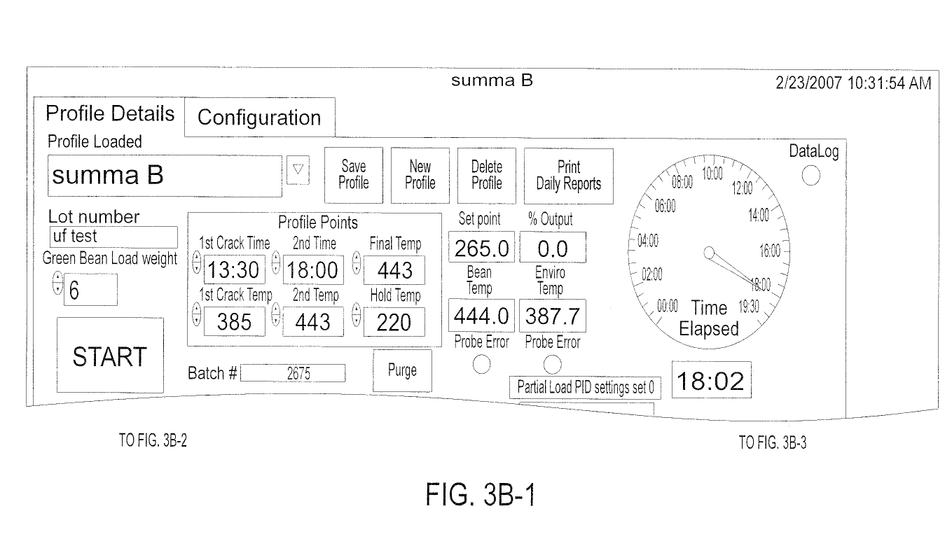

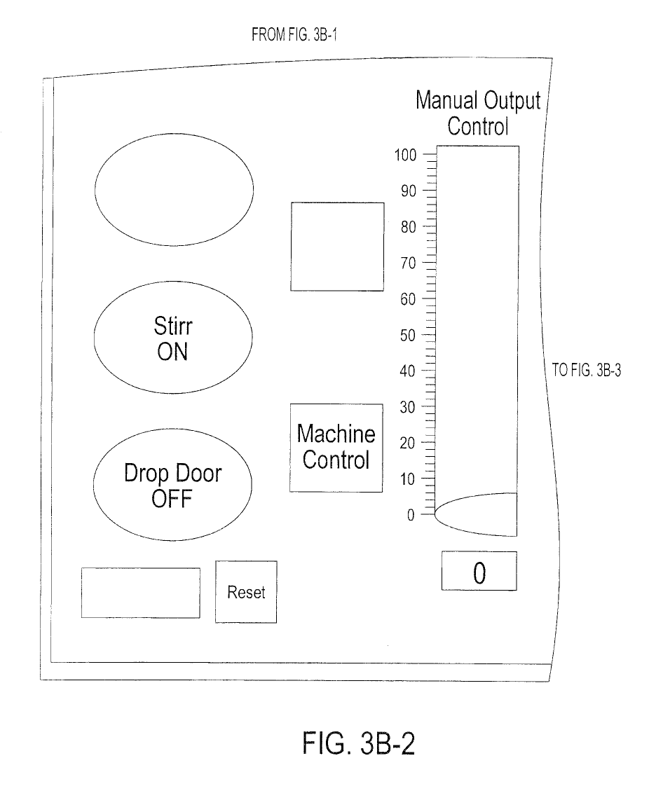

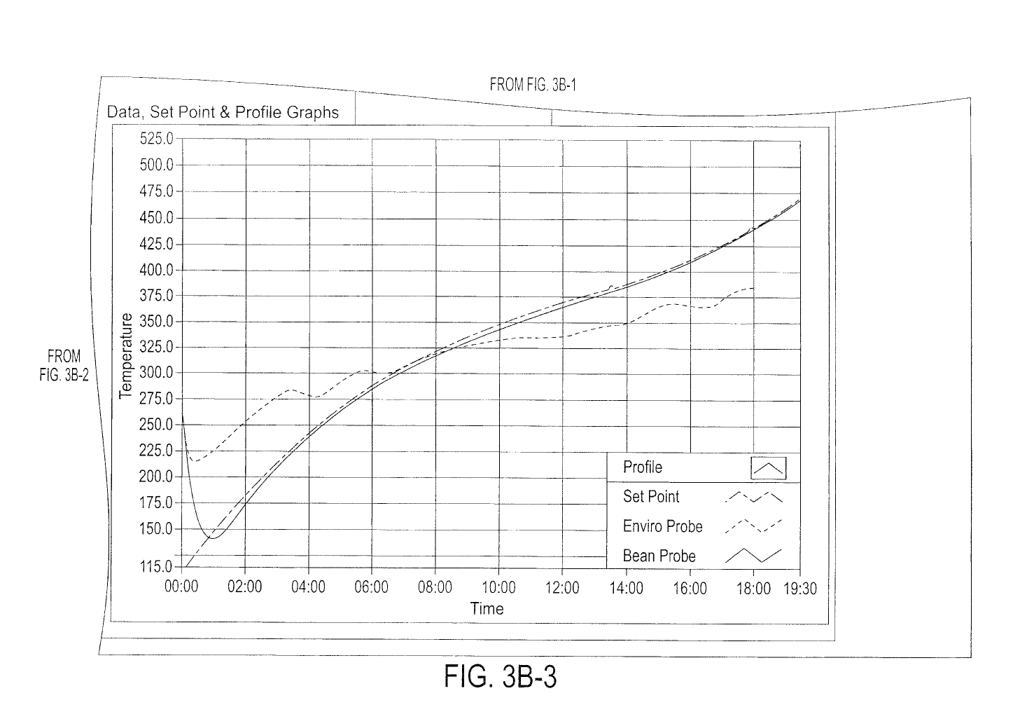

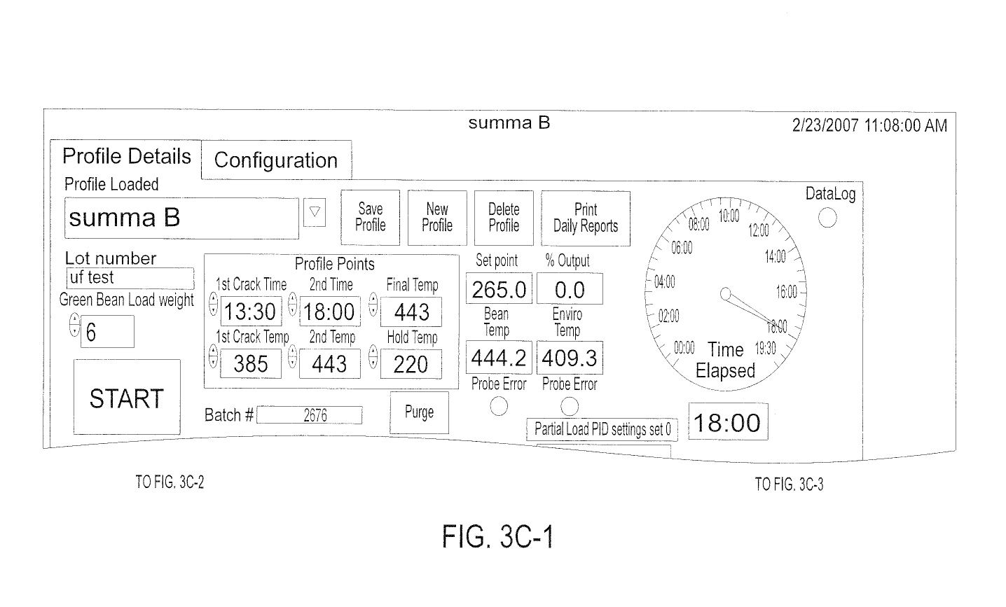

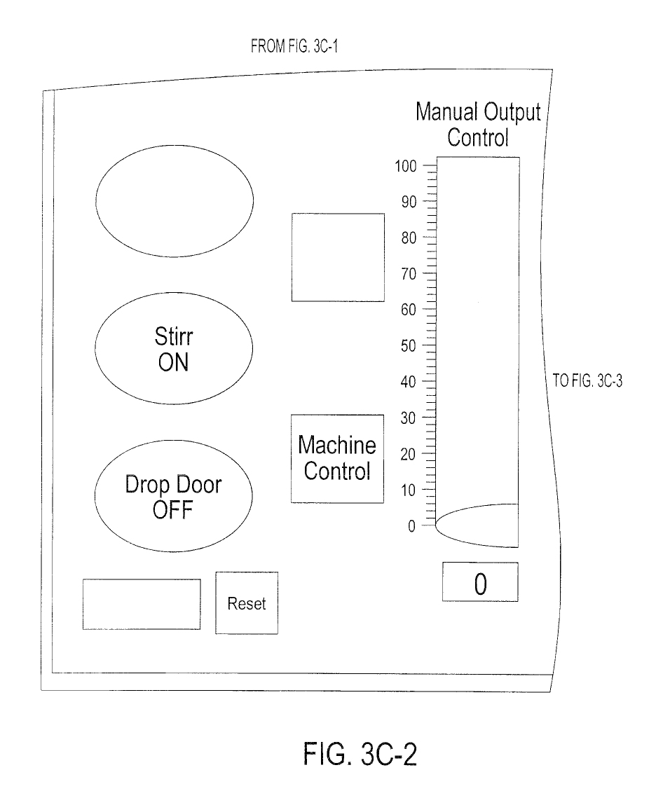

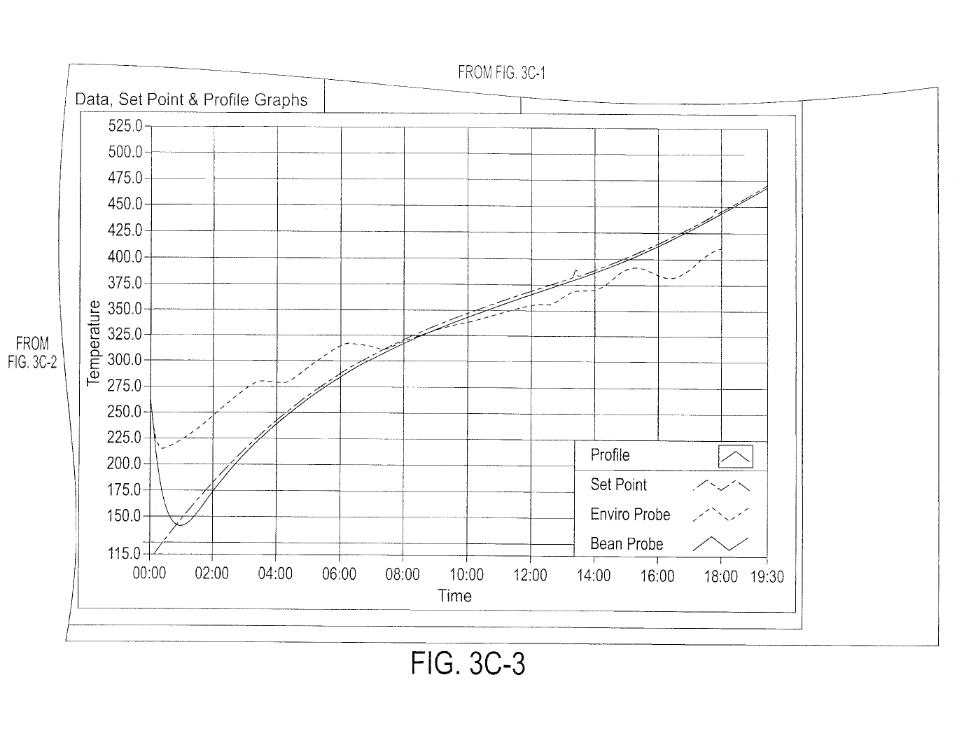

Before comparing treated vs. controls for consumer analysis, the repeatability of the roasting was tested. Three batches of five pounds each were roasted separately. The same roasting profile was used on each batch (FIGS. 3A, 3B, and 3C).

A sensory panel was conducted for three days: Day one Batch A vs. Batch B, Day two Batch B vs. Batch C, and Day three Batch A vs. Batch C. Each batch was ground exactly the same (medium mode) using a Krups GVX2 Burr grinder (Medford, Mass.) and brewed using two Mr. Coffee CG-12 (Boca Raton, Fla.) coffee makers. The coffee to water ratio used was 55 grams of coffee per liter of water.

A triangle test was used. Each day 80 random panelists were asked to first answer some demographic questions such as age and gender. Next, panelists were asked to take a bite of a plain cracker and a sip of water to clean their palate. Later they were presented with three cups of 50 ml fresh brewed coffee at approximately 80° C., two being brewed from the same batch and the other being from a different batch. The panelists were asked to pick the one they believe was the different sample.

TABLE 1
Sensory evaluation results (Batch A vs. B vs. C)

| | Batch A vs. B | Batch B vs. C | Batch A vs. C |
|---|---|---|---|
| Incorrect | 52 | 53 | 58 |
| Correct | 28 | 27 | 22 |
| Total | 80 | 80 | 80 |
| Confidence | 0.583 | 0.49 | 0.109 |
| Significance (p-value) | 0.471 | 0.51 | 0.891 |

Number of correct answers necessary to establish level of significance.

| No. of Judgments | 10% | 5% | 1% | 0.1% |
|---|---|---|---|---|
| 80 | 33 | 35 | 38 | 41 |

The test showed that there were no significant differences between the three batches, showing that the real time control system in the Ambex Y-15 was able to control the roasting profile on each batch consistently with no detectable organoleptic differences. (Table 1)

After establishing the consistency of roasting, treated vs. untreated beans (controls) were evaluated by an informal taste panel. Twelve panelists were asked to evaluate the coffee samples for aroma of ground coffee, as well as aroma and taste of brewed coffee.

Six panelists gave a higher score to the treated coffee over the control and one panelist gave the same score to both, for the ground coffee aroma evaluation. Eight out of twelve panelists graded higher the treated coffee beans over the control on flavor of brewed coffee. Seven panelists graded higher the treated coffee beans over the controls on aroma of brewed coffee, and one gave the same score to both. This informal sensory evaluation suggested a trend in likeability of the treated coffee beans vs. controls, more clearly in the aroma of the brewed coffee.

Headspace flavor analysis and sensory analysis were performed on beans treated without the hull (treated) vs. beans that were wet-processed or fermented (control). A Gas Chromatography-Olfactometry (HP 5890 Series II), also referred herein as GC-O, equipped with an FID detector and a non-polar DB5 column (Zebron, 30 m×0.32 mm ID×0.50 ₃m FT) was performed using SPME with a Supelco (St. Louis, Mo.) bi-polar fiber (50/30 um DVB/Carboxen/PDMS StableFlex (conditions used for the GC-O are provided in Table 2 below).

TABLE 2
Temperature programming conditions used for GC-O

| | Initial | Final | | Final | | | |
|---|---|---|---|---|---|---|---|
| | Oven | Oven | Ramp | Holding | Detector A | Detector | |
| Column | Temp | Temp. | Rate | time | Temp. | B Temp. | Injector |
| Type | (° C.) | (° C.) | (° C./min) | (min) | (° C.) | (° C.) | Temp. (° C.) |
| DB-5 | 40 | 265 | 10 | 5 | 270 | 110 | 220 |

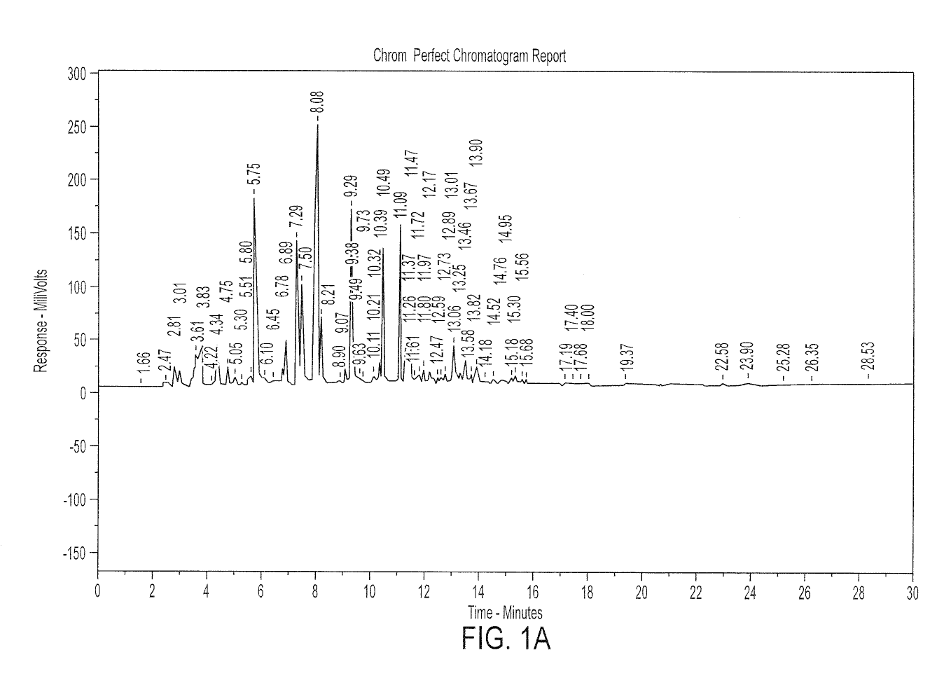

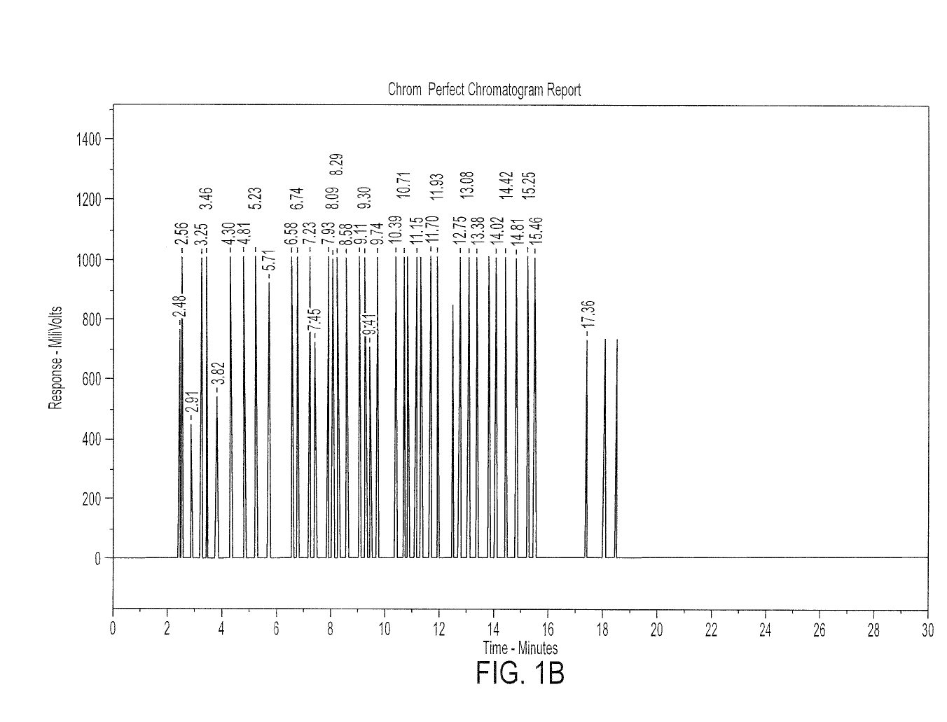

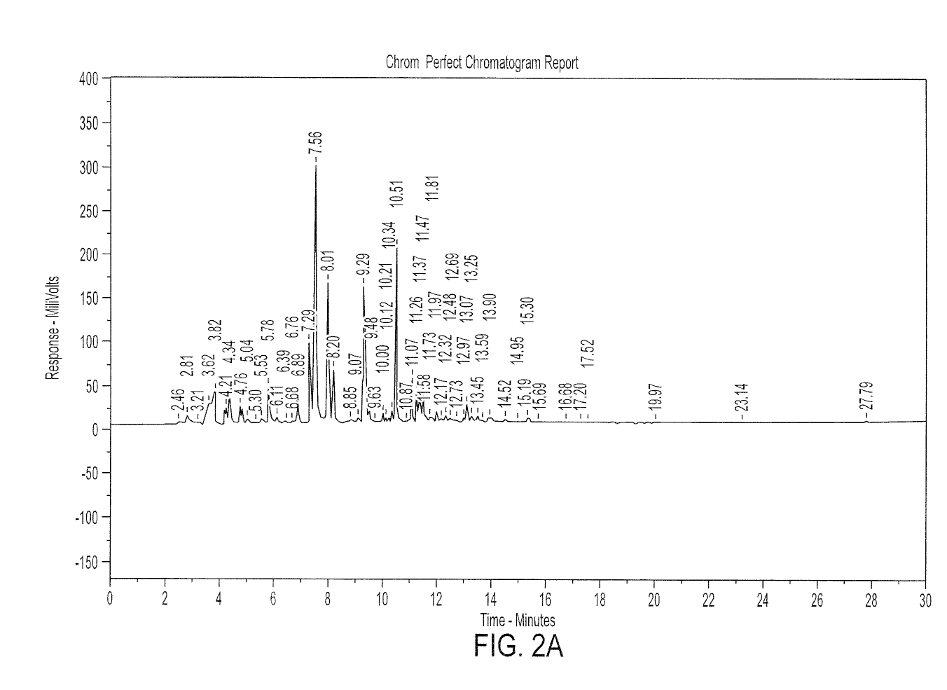

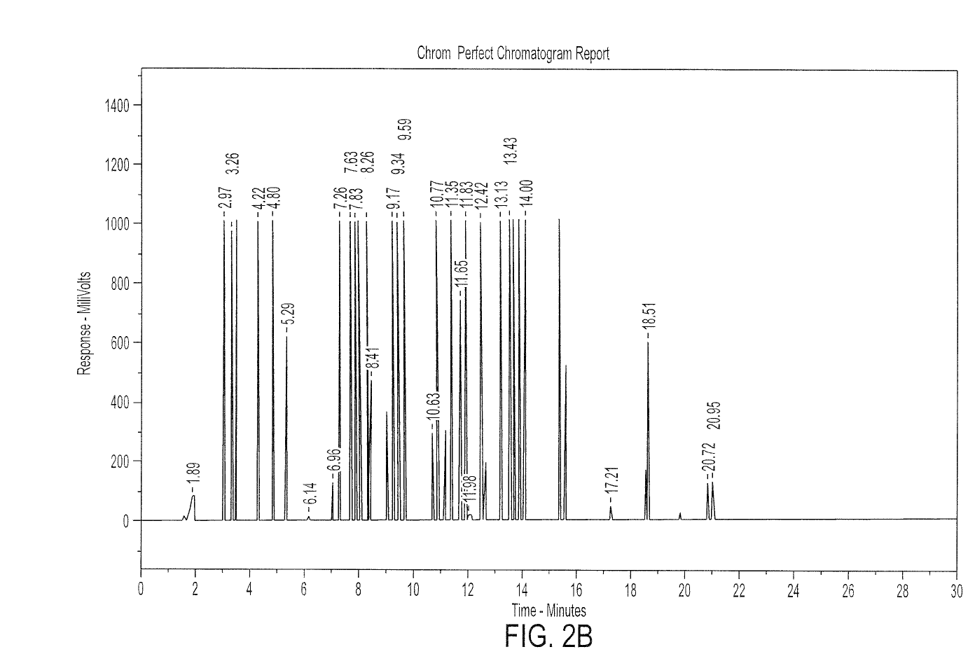

Gas Chromatography (GC) showed an increase in peaks detected (no identification was performed) and more aroma active compounds were recorded with the olfactometry port, on the treated beans (FIGS. 1A and 1B) as opposed to controls (FIGS. 2A and 2B). The olfactometry port description of the detected smells is shown in Table 3.

TABLE 3
Olfactometry port aroma active smell impressions

| Treated coffee | | Control coffee | |
|---|---|---|---|
| Time (min) | Smell | Time (min) | Smell |
| 2.48 | sweet | 2.48 | mint |
| 2.66 | rotten potatoe | 2.58 | banana rotten |
| 2.94 | strange earthy | 3.3 | caramel |
| 3.25 | rancid musty | 3.48 | butter |
| 3.5 | buttery | 4.26 | chocolate cake wet |
| 3.84 | garlic | 4.83 | shoes |
| 4.34 | spicy, wood, tobacco | 5.3 | cooking |
| 4.86 | rancid, pungent, sweet | 7.02 | unknown |
| 5.26 | cured meat | 7.29 | strange tobacco |
| 5.74 | canned tuna | 7.63 | cotton candy |
| 6.6 | onion, fresh | 7.86 | unpleasant |
| 6.78 | mushroom | 8 | used diaper |
| 7.24 | dark beer | 8.29 | medicine |
| 7.51 | glue | 8.49 | old medicine |
| 7.94 | sweet, sour | 9.01 | alcohol |
| 8.09 | dirty, sweet | 9.19 | baked potato |
| 8.29 | roasted nuts | 9.37 | fried chicken |
| 8.55 | rancid nuts | 9.63 | unknown |
| 9.12 | cooked potato | 10.66 | sweet |
| 9.3 | rancid nuts | 10.77 | metal |
| 9.4 | glue | 11.19 | used shoes |
| 9.74 | humid nuts | 11.4 | paint, glue |
| 10.4 | moldy, nutty, sweet | 11.67 | dirty, unpleasant |
| 10.77 | chilly | 11.84 | wet shoes, socks old |
| 10.84 | mushroom | 12.17 | closet |
| 11.17 | sweet gum | 12.44 | flowers old |
| 11.33 | glue unpleasant | 12.61 | fabric |
| 11.7 | glue, alcohol | 13.17 | Licorice |
| 11.9 | rotten garbage, onion | 13.48 | mint, old medicine |
| 12.49 | fresh cut beans | 13.66 | unpleasant |
| 12.74 | caramel | 13.86 | mint, licorice |
| 13.1 | dark coffee | 14.02 | licorice |
| 13.38 | sweet roots | 15.37 | plants |
| 13.83 | unpleasant | 15.5 | mint |
| 14.03 | yeast | 17.3 | unknown |
| 14.44 | sweet, caramel | 18.56 | old wood cabinet |
| 14.8 | pencil, wood | 19.79 | sweet |
| 15.27 | fresh asparagus | 20.78 | sweet |
| 15.44 | liquefied | 21 | gas |
| 17.4 | ginger bread | | |
| 18.1 | sweet | | |
| 18.48 | leather | | |

### Example II

### Enzyme Treatment of Coffee Beans

### Coffee Harvesting

About 77 Kg of coffee cherries (Coffea Arabica L, Limani variety) were harvested at the University of Puerto Rico “Experimental Station” in Adjuntas. PR. They were hand picked at the ripe state maintaining as much color uniformity as possible as instructed to the workers. The cherries were then put in selection tables were they were cleaned of leaves and immature beans. This process was completed in approximately two hours, which prevented fermentation of the harvested beans.

### Green Coffee Processing:

The harvested and cleaned beans were processed by the ecological method. This method was developed to reduce the volume of waste water involved in wet processing while maintaining the characteristics of the wet processed coffee. This method involves the use of an “ecological processing” machine, which pulps the cherries and later removes the mucilage surrounding the parchment by friction. It has been found to be very effective and is starting to be implemented in many large scale operations. This method involves the use of gravity for the whole process, making it more economically attractive. The process used with the subject invention was an ecological coffee processing machine (INGESEC, Ingerieria de Secado, CRA 61 A Numero 27-15, Santa Fe de Bogotá, DC. Colombia, South America). This machine was equipped with a de-pulper, a friction drum to remove the mucilage (not by fermentation) and a size sorting drum.

The processed beans (green beans still covered by the hull) were dried by sun for approximately three days, until 11-30% moisture content was reached. The beans were moved approximately every two hours to maintain uniform drying throughout the batch. After drying, the hull was removed by a pilot size mill or hull remover (Penacus Clausen Inc., Adjuntas, Puerto Rico). The green beans were put in a coffee bag for temporary storage.

### Green Coffee Storage:

Approximately 45 Kg of green beans were put into glass quart jars manufactured by Golden Mason Jars (Muncie, Ind.). Each jar holds approximately 0.9 Kg of green coffee. The coffee was flushed with commercial grade nitrogen gas (Air-Products, Gainesville, Fla.), to replace the air and therefore minimize oxidation. The coffee jars flushed with nitrogen were stored at 1.6° C. in a walk-in refrigerator for one week before roasting.

### Coffee Treatments:

Green beans were treated to partially emulate the digestion process of the Kopi Luwak. This was done using hydrochloric acid (Sigma-Aldrich, St. Louis, Mo.), Pepsin (1:10.000=1 gram of powder contains 10,000 units of pepsin enzyme) from porcine stomach mucosa (Sigma-Aldrich, St. Louis, Mo.), and DI water. The pH necessary for the partial digestion process to be optimum is between 1.5 and 2. The treated beans were dried using a commercial food dryer (Excalibur, Sacramento, Calif.) for approximately eleven hours at 35° C.

### Coffee Roasting:

The beans were roasted as described in the preliminary experiments using an Ambex Y-15 coffee roaster. The roasting profile parameters used are shown in FIGS. 4A and 4B.

### Coffee Grinding and Brewing:

The roasted (treated and controls) beans were ground uniformly using a Krups GVX2 Burr grinder (Medford, Mass.) set to medium and brewed using two Mr. Coffee CG-12 (Boca Raton, Fla.), coffee makers. The coffee to water ratio used was 55 gr of coffee for each liter of water.

### Experimental Design:

Stored green coffee beans (5.45 Kg) were removed from the refrigerator and divided into two batches of 2.72 Kg each, one for treatments and one for control. The treatment batch was put in a plastic container with 0.02 m³ of deionized water and heated using a heat/stir plate until the temperature reached 35 to 37° C. It had an initial pH of 4.7 and was reduced to a pH of 1.75 by addition of hydrochloric acid. Approximately thirty grams of 1:10,000 pepsin from porcine stomach mucosa were added (11.01 grams per Kg) and stirred until dissolved. The pH was 1.8 after the addition of pepsin. The treated batch was maintained at the same temperature for twelve hours, and then removed for cleaning. The beans were washed extensively many times. Before and after treatments, the treated batch had a pH of approximately 4. 68.

After cleaning, both batches were dried to reach 11-30% moisture content (Bee, 2005, supra; Tosello, 1946, supra; Rigitano, 1963, supra) again at a temperature of 35° C. for 11-12 hours. This was controlled by weight measurements every two hours to stop the drying process exactly when all the absorbed water was eliminated reaching the initial weight of the batch. A moisture content analysis was also performed for confirmation (Table 4).

TABLE 4
Moisture content for green, untreated and treated coffee beans

| | Controls | Treated |
|---|---|---|
| Tin weight | 1.02 gr | 1.01 gr |
| Initial weight | 3.00 gr | 3.03 gr |
| Initial weight | 2.76 gr | 2.22 gr |
| Moisture % | 12% | 26% |

Once dried, both batches were put into glass jars and flushed with nitrogen gas to minimize oxidation until roasting. Each jar was marked with a code that would represent each batch.

Roasting was done the following day at Ambex, Inc. (Clearwater, Fla.) using the same roaster. The roasting conditions were the following: Roasting temperature was 228 degrees ° C., the first crack was set at 13:30 minutes and the second crack was set at 18:00, the burners were turned off at 17 minutes, and the beans were removed for cooling after reaching the second crack at 18 minutes. The beans were cooled down for approximately 5 minutes and later packed in aluminum bags, specifically designed for coffee, and heat-sealed to preserve aroma.

### Color and Texture Analysis by Machine Vision and Lens Eye Software:

A digital color machine vision system composed of a Nikon D50 digital camera, a light box and a data analysis software (Lens Eye®) written in Visual Basic by Dr. Murat Balaban (University of Florida, Gainesville, Fla.) was set up following the procedures detailed by Luzuriaga and others, 1997, supra; Luzuriaga, 1999 supra; and, Martinez and Balaban, 2006, supra. The D-50 camera settings are presented in Table 5. RGB (Red, Green and Blue) values, and the L*-(lightness), a*-(redness), and b*-(yellowness) values were calculated. This was performed using circular regions of interest. Three red, blue and green Labsphere (North Sutton, N.H.) references were used for color calibration.

TABLE 5
Nikon D50 camera settings

| | |
|---|---|
| Lens: | 28-80 mm |
| Iso: | 200 |
| Manual: Sutter speed: | ⅙ s. |
| Zoom: | 35 mm. |
| White Balance: | Sun light |
| Focus: | Manual |
| Aperture: | F11 |
| Image Size: | L |

Lens Eye Software was also set up for analysis of texture differences in treated beans and controls on images taken by the scanning electron microscope at 100× magnification. Contours over a given threshold, color primitives, texture primitives, color change index and texture change index were calculated (Balaban, 2007, supra).

The color (or texture) change index (CCI) was calculated using the following formula:

$$CCI = \frac{{I}^{``} AI for all neighboring pixels}{{I}^{``} distances between equivalent circles} \times \frac{number of neighbors}{object area} \times 100$$

AI is the intensity difference and defined as AI=¥(R−Ri)²+(G−Gi)²+(B−Bi)². The significance of difference for L*, a*, and b*, #primitives/area, #primitives>threshold, CCI, and contour values between treatments was determined by analysis of variance (ANOVA) using SAS 9.1 software (Cary, N.C.) at a significance level of [symbol] =0.05.

### Electronic Nose:

A Cyranose® 320 (Smiths Detection, New Jersey, N.J.) composed of 32 thin-film carbon-black polymer sensors was used to sniff the headspace of the coffee samples after roasting. The raw data or sensor resistances were recorded in real time by the Cyranose® 320 data acquisition software. Five replicates were performed. The data was analyzed using Statistica 7.0 Software with multivariate discriminant analysis (Korel, F., Luzuriaga, D. A., Balaban, M. O. 2001. Objective quality assessment of raw tilapia (Oreochromis niloticus) fillets using electronic nose and machine vision. J. Food Sci. 66 (7): 1018-1024; Korel and Balaban, 2002b, supra; A. Alasalvar, C., Odabasi, A. Z., Demir, N., Balaban, M. O., Shahidi, F., Cadwallader, K. R. 2004. Volatiles and flavor of five Turkish hazelnut varieties as evaluated by descriptive sensory analysis, electronicnose, and dynamic headspace analysis/gas chromatography-mass spectrometry. J. Food Sci. 69 (3): 99-106; Oliveira, A. C. M., Crapo, C. A., Himelbloom, B., Vorholt, C., Hoffert, J. 2005. Headspace gas chromatography-mass spectrometry and electronic nose analysis of volatile compounds in canned Alaska pink salmon having various grades of watermarking. J. Food Sci. 70: 419-26).

The e-nose settings used were as follows: 10-s baseline purge at high pump speed, 10-s sample draw at medium speed, 2-s for snout removal, O-s 1^{st} sample gas purge, 30-s 1^{st} air intake purge at high speed, O-s 2^{nd} sample gas purge at high speed, and O-s second air intake purge.

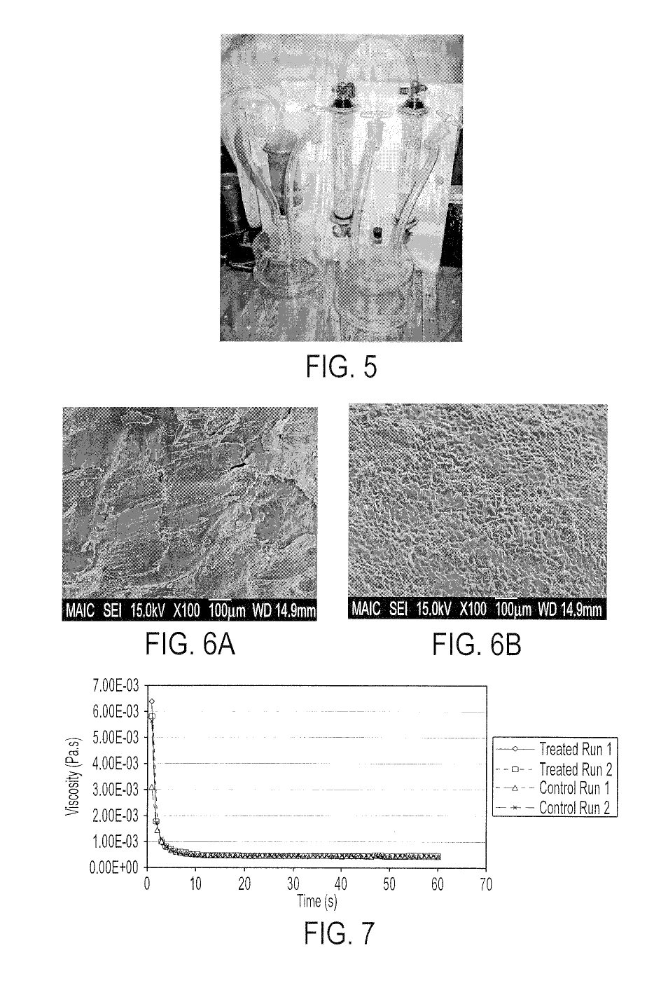

Five grams of samples (treated, controls, batch A, batch B and batch C) were put in an odorless petri plate and placed in a sample holder device designed by Dr. Murat Balaban and Luis Martinez (University of Florida, Gainesville. Fla., 2005) composed of two glass sample holders, one for baseline air and another to place the samples being analyzed, two moisture traps (Alltech hydro-purge II), one activated carbon capsule (Whatman Carbon-Cap) both purchased from Fisher Scientific, and a compressed air tank (Air-products. Gainesville, Fla.) as shown in FIG. 5. An equilibration time of approximately 6-7 minutes was used for each sample. Between samples, the sample holders were flushed with pure air for approximately 10 minutes until no odor was detected. This setup will allow consistent, repeatable and accurate sensor readings from sample to sample.

### Sensory Analysis:

A sensory panel was conducted on the treated samples and control. Each sample was ground using a Krups GVX2 Burr grinder (Medford, Mass.) set to medium and brewed using two Mr. Coffee CG-12 (Boca Raton, Fla.), coffee makers. The coffee to water ratio used was 55 gr of coffee for each liter of water. The test was done at the University of Florida FSHN Dept.'s taste panel facility (University of Florida. Gainesville, Fla.) consisting of 10 private booths with computers. A triangle test is designed to establish if consumers could find differences between the treated beans vs. controls. Eighty random panelists were asked to first answer some demographic questions such as age and gender. Next, the panelists were asked to take a bite of a plain cracker and a sip of water to clean their palate. Later they were presented with three cups of 50 ml fresh brewed coffee at approximately 80° C., one being the control and the other two being treated, alternating with two being controls and one being treated, every other panelist. The panelists were asked to pick the one they believe was the different sample.

A trained panel was also conducted based on the results of the triangle test shown in Table 6. Twelve panelists were trained for different levels of bitterness in coffee samples. The scale was designed from 0 to 15, 0 being the least bitter and 15 the most bitter. Four known standards were used: water (0 bitterness), water+0.3 gr/L of caffeine (5 bitterness), water+0.6 gr/L of caffeine (10 bitterness) and water+0.9 gr/L of caffeine (15 bitterness). Caffeine used was purchased from Fisher Scientific (St. Louis, Mo.).

TABLE 6
Triangle test sensory analysis results (treated coffee vs. controls)
Treated vs. Controls

| | |
|---|---|
| Incorrect | 40 |
| Correct | 40 |
| Total | 80 |
| Confidence | 0.998 |
| Significance (p-value) | 0.002 |

Number of correct answers necessary to establish level of significance.

| No. of Judgments | 10% | 5% | 1% | 0.1% |
|---|---|---|---|---|
| 80 | 33 | 35 | 38 | 41 |

Panelists were exposed to the bitterness scale and the known standards in several sessions. Cups with 50 ml of liquid were used. Once they were able to identify each of the standards within the scale, they were presented an unknown sample (water and 0.45 gr/L of caffeine), and it was asked that they placed the sample in the correct place within the bitterness scale. This was done in two sessions until no error was detected. Finally panelists were presented with an unknown (treated coffee sample) marked with a random number. They were asked to place this sample within the bitterness scale. They were asked to take a bite of a cracker and a sip of water to clean their palate between standards and between samples. Later they were presented with a second unknown (control coffee sample) marked with another number. Again they were asked to place this sample within the bitterness scale. The results were analyzed to report where the two samples fall within the bitterness scale and the difference in bitterness that occurred as a result of the treatments.

### Coffee Cupping:

Coffee cupping was performed by a roast master and professional cupper at Ambex Inc.—Cinnamon Bay Coffee Roasters (Clearwater, Fla.). The treated beans and controls were evaluated for different attributes such as fragrance/aroma (e.g., flower, herbal, fruit, nutty, caramel, vanilla, spicy, chocolaty, earthy), sweetness (e.g., lively, delicate, fine, nature), flavor (e.g., chocolate, caramel, fruit, herbal, flower, citrus, nutty, berry, deep, complex, balanced), acidity (e.g., delicate, moderate, intense, smooth, gentle, fruity, citrus, astringent, sharp), aftertaste (e.e., weak, moderate, unforgettable, long, round, clean, dirty, musty), body (e.g., round, delicate, light, medium, full, heavy, intense, creamy, rich), balance, uniformity, cupper perception, and clean cup. An overall quality grade between 6 (good) and 10 (excellent) was given to each sample.

### Scanning Electron Microscope:

The surface of green and roasted coffee beans was analyzed before and after treatments for differences using a JEOL 6330F field emission scanning electron microscope (JEOL Inc. Tokyo, Japan). Four treated beans and four control beans were placed on two different circular sample holders. Both sample holders and beans were coated by a mixture of Gold and Palladium (Au—Pd) for better conductivity. The SEM was setup to take images at 1 5 KV. Several images were obtained at different magnifications, but only the images at a 100× magnification were analyzed for texture differences using the machine vision system and Lens Eye® software mentioned before.

### Example III

### Quantification of Effects of Treatment on Coffee Beans

Quantification of changes in flavor, texture, aroma and color of coffee beans as a result of acid and enzyme treatments was determined by Sensory Analysis, Scanning Electron Microscope, Electronic Nose and Machine Vision.

### Sensory Analysis

To quantify the changes in flavor of coffee beans as a result of treatments, first it was necessary to establish if statistically there were significant differences between the treated samples and controls. For this purpose a sensory panel was conducted. A triangle test was performed with both samples and 80 panelists (see Table 6, above).

Forty out of 80 panelists were able to choose the sample that was different from the other two, meaning that there are significant differences between samples even at 1% error, for which 38 would be necessary to establish significant differences.

If the correct sample was chosen, the panelists were asked to comment on the differences found between the samples. Most of the comments were found to be related to bitterness of the samples. The treated samples were found to be less bitter than controls.

Marcone (2004, supra) suggested that in the digestive tract of the Kopi Luwak the acids and enzymes might have broken down and even leached out (due to protein content differences between Kopi Luwak and controls) some of the proteins causing bitterness of the final cup, therefore the Kopi Luwak was found to be less bitter than regular coffee. The action of the proteases used for treatment might have also caused the reduction of bitterness of the treated sample compared to its controls.

A trained sensory panel was developed to evaluate the bitterness of samples. Panelists (12) were trained using solutions of different percentages of caffeine (0% (1 in the bitterness scale), 0.05% (5 in the bitterness scale), 0.08% (10 in the bitterness scale, and 0.15% in water (15 in the bitterness scale). The procedure is detailed above.

The trained panelists evaluated the treated and control samples and placed them on the bitterness scale. The results are shown in Table 7.

TABLE 7
Trained panel results (treated vs. control coffee samples)

| | Bitterness Scale | | |
|---|---|---|---|
| | Between | Between | Between |
| | 1 and 5 | 5 and 10 | 10 and 15 |
| Treated | | 4* | 8* |
| Control | | 1* | 11* |
| # panelists that found: | | | |
| a) Treated sample | | | 10 |
| less bitter than control | | | |
| b) Control less bitter | | | 2 |
| than treated sample | | | |

*Number of panelist that placed the coffee samples between the controls

Overall ten out of twelve panelists found the treated coffee less bitter than controls. Four out of eight panelists found the treated coffee belong between 5 and 10 on the bitterness scale; the other 8 panelists found the treated coffee belong between 10 and 15 on the bitterness scale. Only one panelist found the control sample belongs between 5 and 10 on the bitterness scale, the rest found the control to belong between 10 and 15 in the bitterness scale. Within the 10 to 15 range in the bitterness scale, the control samples were placed significantly higher, while the treated sample was placed lower in the scale. To confirm that the treatments did not extract caffeine causing the reduction of bitterness, 100 grams of treated coffee (whole beans) and 100 grams of control coffee (whole beans) were analyzed for caffeine content in duplicate at ABC Research Corporation (Gainesville, Fla.) following the Food Additives Analytical Manual Method 79 (FDA, 5600 Fishers Lane, Rockville, Md. 20857).

Treated samples 1 and 2 were found to have 0.768% caffeine (g/100 g) dry basis, while Control sample 1 was found to have 0.894% caffeine (g/100 g) dry basis, and Control sample 2 was found to have 0.871% caffeine (g/100 g) dry basis. The detection limit was 0.001.

Although the treated samples were found to have slightly less caffeine than the controls, the difference is not sufficient to justify the difference in bitterness between the treated and control samples due to treatments.

Two bags of 0.11 Kg each were prepared and labeled with numbers to indicate treated coffee the controls. These numbered coffee samples were presented to a professional cupper in Ambex Coffee Roasters (Clearwater, Fla.). The samples were evaluated and commented on based on the attributes mentioned above (Table 8). These attributes represent the perception of a professional cupper regarding the coffee samples, however, differences found do not necessarily represent “good” or “bad” quality attributes.

TABLE 8
Professional cupping evaluation of roasted treated vs. control coffee samples

| Treated Sample | Control Sample |
|---|---|
| Fragrance/Aroma: Caramel to slight | Fragrance/Aroma: Fruitiness in dry |
| chocolate, spice at break. Slight alcohol | fragrance, more herbal in aroma, similar to |
| aroma. | green peas. |
| Sweetness: Slight. | Sweetness: Natural sweetness, moderate. |
| Flavor: Smokiness predominant. | Flavor: Super sharp, herbal. |
| Aftertaste: Little after taste, smoky flavor | Aftertaste: Chalky aftertaste with |
| disappeared quickly, as it cooled the | bitterness. |
| alcohol present in the aroma was felt in the | |
| cup. A bit of fermentation was found. | |
| Acidity: Flat with very little acid sparkle. | Acidity: Tart brightness, green vegetables, |
| | undeveloped roast or enzymatic flavor |
| | from roasting. |
| Body: Light, thin, very little viscosity, | Body: Medium body, moderate mouth- |
| contributing little to the aftertaste. | feel. |
| Balance: The initial flavor was so intense; | Balance: The sharpness of the cup is not |
| it resulted in an unbalanced cup | balanced with other characteristics, |
| | becoming a distraction throughout the |
| | cupping, imbalance is more pronounced as |
| | the cup cooled. |

The same sample preparation was used for both samples, as suggested by the Specialty Coffee Association of America “SCAA”. 2002. “The art of aroma perception in coffee” (Poster). The cupper was presented with both samples only labeled with random numbers for evaluation.

Fragrance/aroma is the first smell perceived after the water is poured into the cup Of ground coffee. As seen in Table 8, the treated sample was found to have caramel to slight chocolate smell with a spike at break, which is the point where the coffee layer at the surface is broken down by the use of a spoon which causes the release of aroma trapped under the coffee layer. This gives the cupper a better perception of aroma. Also a slight alcohol aroma was perceived. The control sample was found to have a very different fragrance/aroma than the treated sample. It was found to have herbal aroma similar to green peas, and also fruitiness in the dry fragrance.

Next, the samples were tasted to comment on flavor attributes. In terms of sweetness, both samples were found to be different. Control sample was found to have moderate or natural sweetness, and treated sample was found to have very slight sweetness. Flavor was also different for both samples. Control sample was found to have a super sharp and herbal flavor, while treated sample was found to have smokiness as a predominant flavor. Until this point, it was very clear that the treatments have caused changes in many attributes, but not until the acidity, aftertaste, body and aroma were evaluated could the cupper evaluation to previous results and also expected changes be correlated.

In terms of acidity, treated sample was found to be flat with very little acid sparkle, and control sample was found to have tart brightness, and a green vegetable taste, an undeveloped roast or enzymatic flavor was found on the taste as a result of processing, common in a medium-dark roasted coffee.

Treated sample was found to have very little aftertaste. Also the original smoky flavor originally found in the fragrance/aroma disappeared. As it cooled down, the alcohol smell found in the fragrance/aroma became present in the cup and a little fermentation flavor was also found. On the other hand, control sample was found to have a bitter aftertaste, not found in the treated coffee.

The body of treated sample was found to be very thin with little viscosity to the cup. The initial flavor of this sample was very intense, resulting in an unbalanced cup. Control sample was found to have a medium body and moderate mouth feel. Also the sharpness of the cup was not balanced with the other characteristics, becoming a distraction throughout the cupping. Imbalance was found to be more pronounced as the cup cooled down.

Measurement of viscosity was conducted using a TA Instruments Ltd. Advanced Pheometer AR2000 (New Castle, Del.) to quantify differences in viscosity between treated and control. The samples (in duplicates) were submitted to a sheer stress with a peak hold at 0.026 Pa. The viscosity of each sample was calculated and plotted over time (FIG. 7).

The time interval of 0 seconds to 10 seconds represents the equilibration period, after a time of 60 (s) it can be seen that the two samples and their replicates overlap exactly showing that there is no difference in viscosity of both treated and control samples. This suggests that the body difference mentioned by the professional cupper does not reflect physical viscosity.

### Scanning Electron Microscope:

In order to determine surface changes to the beans as a result of treatments, scanning electron microscope (SEM) analysis was performed on both samples at different magnifications. Many differences were found between the treated and control samples. Overall, the appearance of the controls was different than the treated samples. The controls showed the structure of the surface to be a superposition of individual layers, not uniform at all. The surface shown in FIG. 6A was seen in 5 replicates studied with the SEM.

The treated beans showed a surface not smooth, but very uniform. FIG. 6B shows the surface of a treated bean at a magnification of 100×. The acids and enzymes used for the treatments may have caused pitting and the removal of layers of organic matter causing the differences seen in FIGS. 6A and 6B.

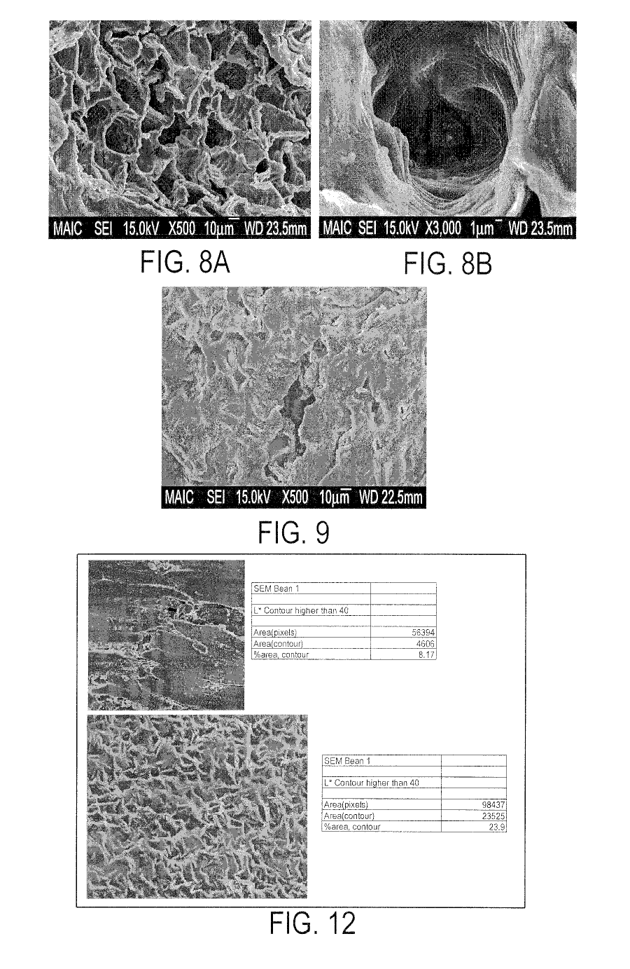

Other differences were found between the treated samples and controls. The presence of holes in specific parts of the treated beans was observed. Caves or tunnels are believed to be formed as a result of the enzymes. These holes are located at specific points on the beans, suggesting that it could be possible that these locations contain protein bands or higher protein content. At a higher magnification, the holes or tunnels were captured to establish a better view. In FIGS. 8A and 8B it can be seen in the image of the holes on the surface of the beans, and also an image of the inside of the holes.

The controls at some parts showed some cracks and structures similar to a hole, but were clearly different as seen in FIG. 9. Kopi Luwak also showed holes and tunnels by SEM analysis. These holes were observed at different parts of the beans. This, however, is uncomparable with treated beans since the beans are not of the same origin.

The surface of the treated samples and controls after roasting were also evaluated. The treated beans were found to be smoother and more uniform than controls. The acids and enzymes have partially removed the external layers of the bean during treatments causing the smoothness of the treated samples, not shown in the control samples.

In order to quantity the differences round in the treated beans and its controls, eight treated beans and eight control beans were coated with Au—Pd, and evaluated using the SEM at 100×. Several images of different parts of the bean were taken. Lens Eye Color Expert® was used to analyze the images and quantify color and texture differences present in each sample.

Color primitives, texture primitives and contours were evaluated on each image of the treated samples and controls with the purpose of developing and testing a way to analyze and quantify changes that can be obvious to the human eye. FIGS. 10, 11 and 12 are examples of the different evaluations with their results. The number of primitives found on each of the images, as well as the number of primitives that exceeded a determined blob threshold was divided by the surface area of the image for standardization, and to allow the data to be comparable from image to image (Table 9).

SAS was used to determine if there were significant differences between treatments, in terms of # primitives, # primitives>blob threshold, Color Change Index, and contours, by conducting an Analysis of Variance (ANOVA) test.

TABLE 9
Visual texture analysis results. Color primitives (threshold = 35)

| | | | # | #primitives > blob | Color |
|---|---|---|---|---|---|
| Coffee | | | primitives/ | threshold/ | Changing |
| Type | Treatment | Rep. | area | area | Index |
| Green | control | 1 | 0.033 | 0.0021 | 22.18 |
| Green | control | 2 | 0.033 | 0.0017 | 10.52 |
| Green | control | 3 | 0.028 | 0.0013 | 7.54 |
| Green | control | 4 | 0.019 | 0.0012 | 2.42 |
| Green | control | 5 | 0.014 | 0.0014 | 2.32 |
| Green | control | 6 | 0.012 | 5.3E−04 | 1.065 |
| Green | treated | 1 | 0.048 | 0.0049 | 21.55 |
| Green | treated | 2 | 0.042 | 0.0022 | 10.23 |
| Green | treated | 3 | 0.025 | 0.0039 | 9.89 |
| Green | treated | 4 | 0.031 | 0.0030 | 7.64 |
| Green | treated | 5 | 0.040 | 0.0025 | 10.41 |
| Green | treated | 6 | 0.023 | 0.0031 | 7.23 |

TABLE 10
SAS results for texture analysis color primitives with threshold = 35

| Control vs. Treated | | ANOVA | | | | *t grouping | |
|---|---|---|---|---|---|---|---|
| Variable | DF | SS | Mean Square | F Value | Pr > F | Control | Treated |
| # Primitives/area | 1 | 4.4E−04 | 4.4E−04 | 5.01 | 0.049 | B | A |
| # Prim. > blob | 1 | 1.1E−05 | 1.1E−05 | 17.32 | 0.0019 | B | A |
| threshold/area | | | | | | | |
| Color Changing | 1 | 36.44 | 36.44 | 0.8 | 0.39 | A | A |
| Index | | | | | | | |

*Means with the same t grouping letters are not significantly different.

Table 10 shows the SAS results on texture analysis based on color primitives with a threshold of 35 results. For the number of primitives found per unit of area, there is a significant difference between treated beans and controls. There is a possibility for error since the Pr>5 is close to 0.05. In terms of the # of primitives above blob threshold per unit of area, this method shows a significant difference between treated samples and controls. The Color Change Index, however, does not show a significant difference. The means also show a good separation and a significant difference on the number of primitives found per unit of area and also in the number of primitives above the blob threshold; the means did not show a difference on the CCI, as seen by the grouping in Table 10. The results obtained with this method suggest that analyzing color primitives in the visual texture of green coffee beans can be used for quantification of surface differences.

Visual texture was also analyzed for texture primitives with a threshold of 25 (Table 11). SAS was performed to establish statistical differences (Table 12).

TABLE 11
Visual texture analysis results. Texture primitives with threshold = 25

| | | | | #primitives > | Texture |
|---|---|---|---|---|---|
| Coffee | | | | blob | Change |
| Type | Treatment | Rep. | # primitives/area | threshold/area | Index |
| Green | control | 1 | 0.018 | 3.3E−04 | 7.01 |
| Green | control | 2 | 0.014 | 2.5E−04 | 5.08 |
| Green | control | 3 | 0.013 | 2.6E−04 | 3.47 |
| Green | control | 4 | 0.0025 | 6.82E−05 | 0.51 |
| Green | control | 5 | 0.0024 | 7.48E−05 | 0.36 |
| Green | control | 6 | 0.0011 | 4.20E−05 | 0.15 |
| Green | treated | 1 | 0.027 | 3.1E−04 | 11.15 |
| Green | treated | 2 | 0.016 | 1.4E−04 | 6.36 |
| Green | treated | 3 | 0.0093 | 1.5E−04 | 2.62 |
| Green | treated | 4 | 0.012 | 7.33E−05 | 2.72 |
| Green | treated | 5 | 0.017 | 1.1E−04 | 5.59 |
| Green | treated | 6 | 0.0078 | 9.75E−05 | 2.07 |

TABLE 12
SAS results for texture analysis texture primitives with threshold = 25

| Control vs. Treated | | | Mean | | | *t grouping | |
|---|---|---|---|---|---|---|---|
| Variable | DF | ANOVA SS | Square | F Value | Pr > F | Control | Treated |
| # Primitives/area | 1 | 1.2E−04 | 1.2E−04 | 2.12 | 0.18 | A | A |
| # Prim. > blob | 1 | 1.54E−09 | 1.54E−09 | 0.13 | 0.72 | A | A |
| threshold/area | | | | | | | |
| Color Changing | 1 | 16.20 | 16.20 | 1.6 | 0.23 | A | A |
| Index | | | | | | | |

*Means with the same t grouping letters are not significantly different.

SAS showed no difference in any of the variables with this method which was also confirmed by the t grouping of the means. However this method may still be good for evaluation of texture differences at a different threshold.

Visual texture analysis was also evaluated with a threshold of 15. The results (Table 13) were analysed with SAS to establish significant differences (Table 14).

TABLE 13
Visual texture analysis results. Texture primitives with threshold = 15

| | | | | | Texture |
|---|---|---|---|---|---|
| Coffee | | | # primitives/ | #primitives > blob | Change |
| Type | Treatment | Rep. | area | Threshold/area | Index |
| Green | control | 1 | 0.06 | 9E−04 | 74.32 |
| Green | control | 2 | 0.05 | 8.3E−04 | 63.02 |
| Green | control | 3 | 0.05 | 6.6E−04 | 27.60 |
| Green | control | 4 | 0.01 | 6.8E−05 | 4.03 |
| Green | control | 5 | 0.02 | 3.2E−04 | 4.23 |
| Green | control | 6 | 0.02 | 1.5E−04 | 1.69 |

TABLE 13
Visual texture analysis results. Texture primitives with threshold = 15

| | | | | | Texture |
|---|---|---|---|---|---|
| Coffee | | | # primitives/ | #primitives > blob | Change |
| Type | Treatment | Rep. | area | Threshold/area | Index |
| Green | control | 7 | 0.03 | 0.0014 | 3.40 |
| Green | control | 8 | 0.09 | 0.0019 | 6.55 |
| Green | treated | 1 | 0.06 | 0.0012 | 75.71 |
| Green | treated | 2 | 0.05 | 3.6E−04 | 34.72 |
| Green | treated | 3 | 0.06 | 0.0012 | 37.16 |
| Green | treated | 4 | 0.06 | 5.1E−04 | 21.77 |
| Green | treated | 5 | 0.04 | 3E−04 | 31.45 |
| Green | treated | 6 | 0.02 | 3.7E−04 | 17.59 |
| Green | treated | 7 | 0.04 | 3.1E−04 | 8.31 |
| Green | treated | 8 | 0.04 | 5.7E−04 | 20.89 |

TABLE 14
SAS results for texture analysis texture primitives with threshold = 15

| Control vs. Treated | | ANOVA | Mean | | | *t grouping | |
|---|---|---|---|---|---|---|---|
| Variable | DF | SS | Square | F Value | Pr > F | Control | Treated |
| # Primitives/area | 1 | 1.2E−04 | 1.2E−04 | 0.26 | 0.61 | A | A |
| # Prim. > blob | 1 | 1.17E−07 | 1.17E−07 | 0.43 | 0.52 | A | A |
| threshold/area | | | | | | | |
| Color Changing | 1 | 246.12 | 246.12 | 0.38 | 0.54 | A | A |
| Index | | | | | | | |

*Means with the same t grouping letters are not significantly different.

This method also shows no difference in any of the variables, and it is also confirmed by the t grouping of the means showing the same letter for treated and controls on all variables. These results suggest that the texture analysis of texture primitives at thresholds of 25 and 15 are not sufficient for quantification of significant differences in the texture of green coffee beans.

TABLE 15
Visual texture analysis results. Contour analysis
L* contour >40

| | | | % Area (Area |
|---|---|---|---|
| | | | contour/ |
| Coffee Type | Treatment | Rep. | area pixels) |
| Green | control | 1 | 8.17 |
| Green | control | 2 | 10.56 |
| Green | control | 3 | 7.78 |
| Green | control | 4 | 1.99 |
| Green | control | 5 | 5.52 |
| Green | control | 6 | 3.54 |
| Green | treated | 1 | 23.9 |
| Green | treated | 2 | 10.65 |
| Green | treated | 3 | 15.89 |
| Green | treated | 4 | 11.2 |
| Green | treated | 5 | 13.78 |
| Green | treated | 6 | 14.44 |

TABLE 16
SAS results for contour analysis L* contour >40

| | | ANOVA | Mean | F | | t grouping | |
|---|---|---|---|---|---|---|---|
| | DF | SS | Square | Value | Pr > F | Control | Treated |
| Variable | 1 | 227.94 | 227.94 | 13.75 | 0.0041 | B | A |
| Area | | | | | | | |

*means with the same t grouping letters are not significantly different

Table 16 shows the SAS results on texture analysis based on contours analyzed for L*higher than a threshold of 40 (Results shown in Table 15). This method showed that there is a significant difference between treated green coffee beans and its controls. The means also show a significant difference between treated green coffee beans and its controls.

The analysis of contours of L* values over a threshold of 40 is also found to be effective in quantification of differences in the visual texture of green coffee beans.

### Electronic Nose:

A Cyranose® 320 (Smiths Detection. New Jersey, N.J.) having 32 thin-film carbon-black polymer sensors was used to analyze the headspace of the coffee samples after roasting. The treated coffee, the controls and the three batches A, B and C used for preliminary tests were sniffed separately five times. An equilibration time in the same chamber of approximately 6-7 minutes was used for each sample. Between samples, the sample holders were flushed with pure air for approximately 10 minutes until no odor was detected.

The sensor resistances were recorded for each run for the duration of the sniffing, starting from the baseline purge, through the sample sniff and the sensor purge. All the data generated by the 32 sensor resistances for each step of the sniff were analyzed to obtain the maximum difference from the baseline to the highest resistance point of the sample exposure step within the sniff (AR/R). This was done by Cyranose Analysis software written by Dr. Murat Balaban (University of Florida. Gainesville, Fla.). All the AR/R values for each sensor for each of the samples were put in a spreadsheet in Excel and each value was multiplied by 1000 since the values were small. Also within each sample, an average AR/R value, standard deviation and % error were calculated for each sensor.

The AR/R values for each sensor were plotted by the Cyranose Analysis software. Some sensors showed a higher AR/R value than others, which means that these sensors are more sensitive to the coffee aroma than others.

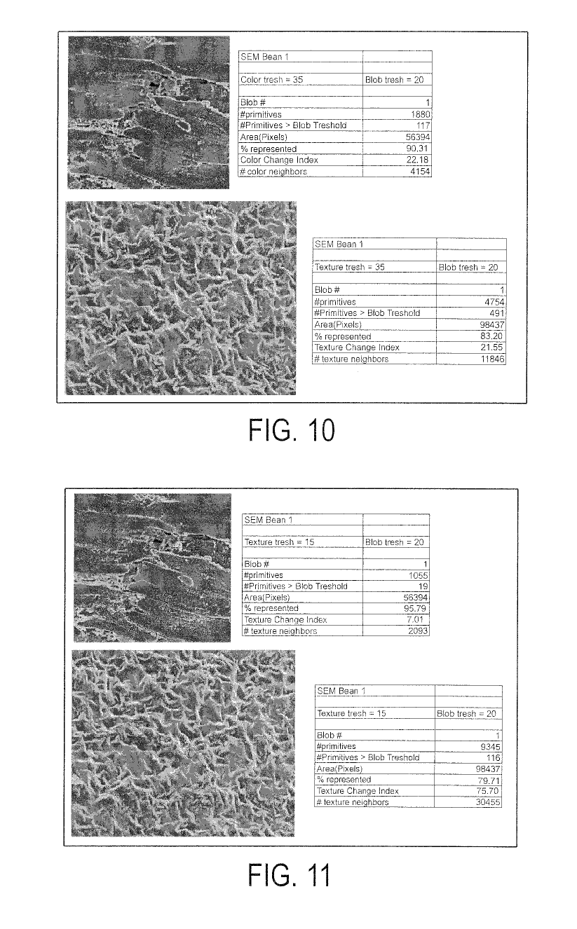

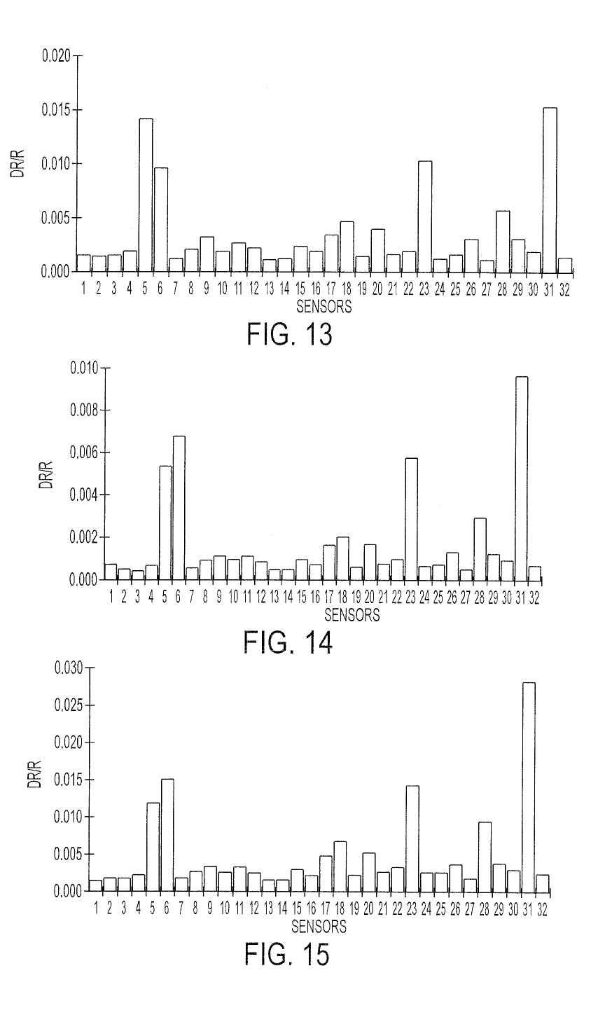

To be able to analyze the AR/R values with discriminant function, twelve sensors with the highest AR/R values for each sample were chosen (FIG. 13). Each sensor chosen was also matched with the % error calculated in Excel to make sure that the most sensitive sensors also have low error %.

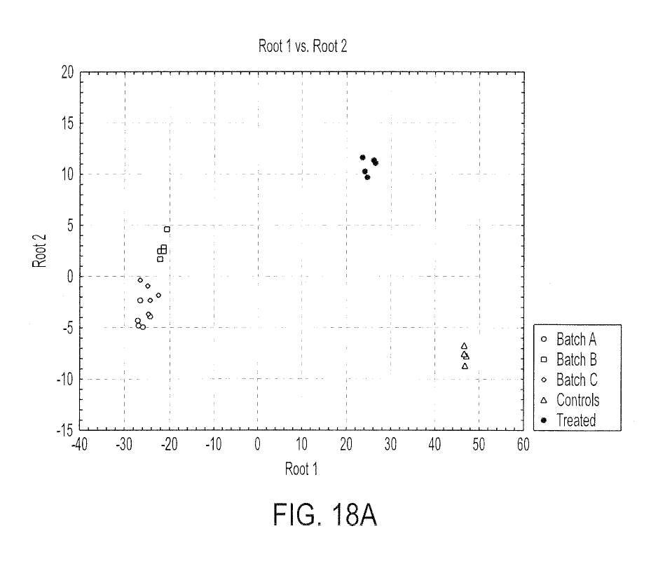

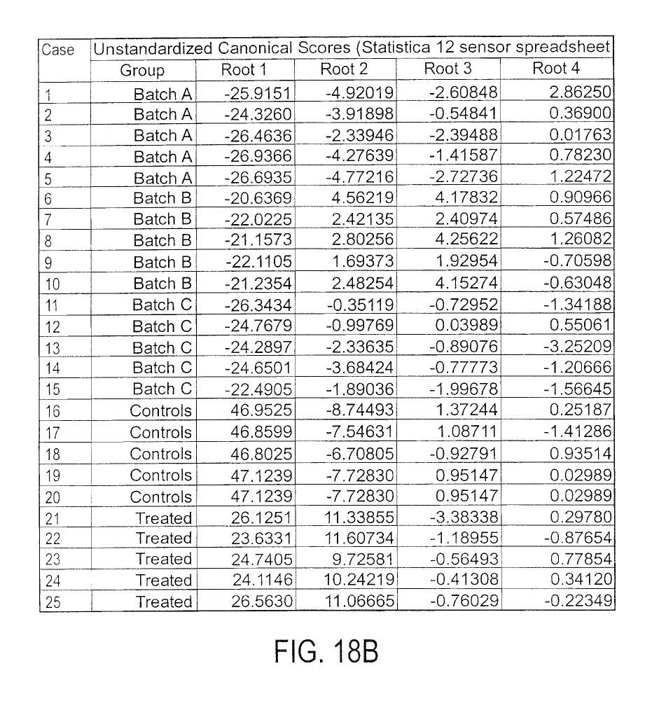

The sensors chosen for discriminate function analysis were sensors 5, 6, 9, 11, 17, 18, 20, 23, 26, 28, 29, and 31. No significant differences can be seen between Batches A, B and C. The “R/R for each of the 12 sensors chosen were very similar, which was confirmed by the Root 1 vs. Root 2 graph based on the unstandardized canonical scores of each sample, as seen in FIG. 18A.

As seen in FIGS. 14 and 15, the “R/R values for the controls are much smaller than that of the treated sample (see Y axis scale), which means that the sensor resistance difference from the baseline to the maximum point of the sample exposure is greater in the treated sample than control.

Discriminate function analysis plot (FIG. 18A) of unstandardized canonical scores (FIG. 18B) shows a clear separation of the treated beans from the controls.

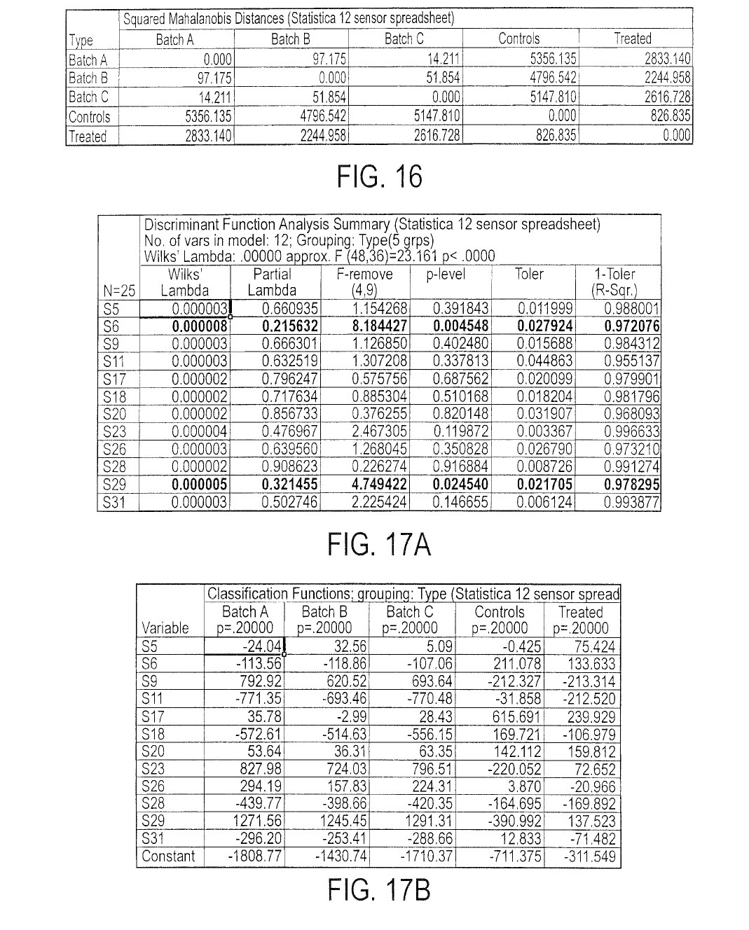

The squared Mahalanobis distances calculated by Statistica 7.0 also show how distant each sample group is from the other, as seen in FIG. 16. The discriminate function analysis summary, the F values and the p-levels for each sample are shown in FIGS. 17A and 17B.

### Machine Vision

Color analysis was performed by a machine vision system. The average L*, a* and b* values were measured on green, roasted and ground control and treated samples, each with 2 duplicates. Three Labsphere red, green and blue true color standards were used for color calibration.

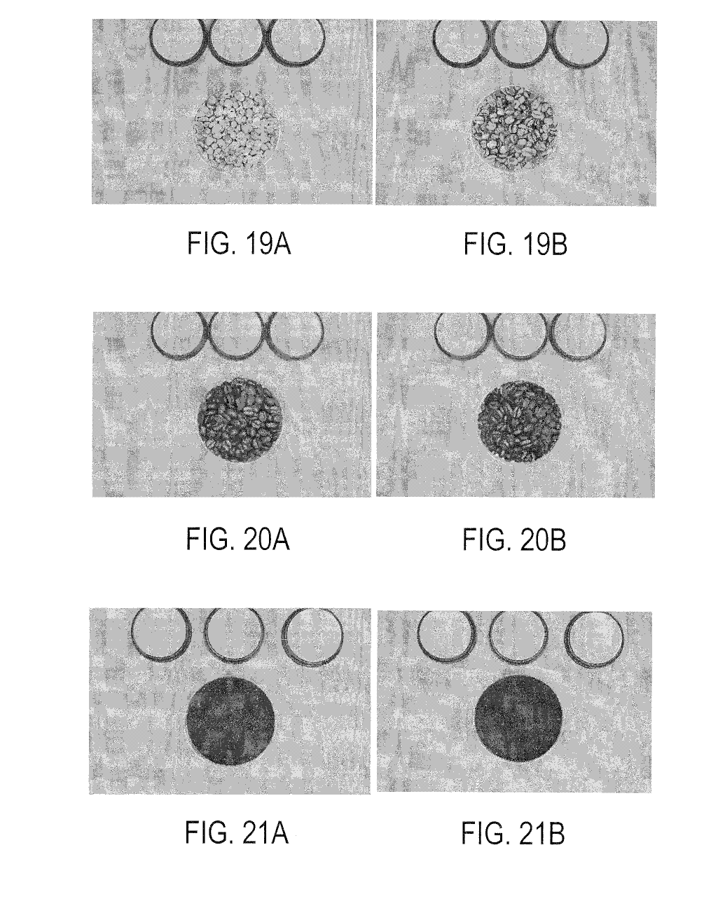

Before treatments, the green coffee had a typical olive color (FIG. 19A). This color changed for the samples that were treated, from olive to an olive brown or brown (FIG. 19B). This change was visually very clear. The average L*, a* and b* values were calculated and analyzed by SAS for statistical differences using an Analysis of Variance (ANOVA) test.

TABLE 17
Color analysis results: Green, roasted and ground (treated and control)

| Coffee Type | Treatment | Rep. | L* | a* | b* |
|---|---|---|---|---|---|
| Green | control | 1 | 43.87 | −1.57 | 24.19 |
| Green | control | 2 | 43.2 | −1.54 | 24.34 |
| Green | treated | 1 | 26.09 | 3.18 | 19.85 |
| Green | treated | 2 | 25.52 | 3.75 | 20.14 |
| Roasted | control | 1 | 8.13 | 6.07 | 7.49 |
| Roasted | control | 2 | 9.15 | 5.91 | 7.46 |
| Roasted | treated | 1 | 5.44 | 2.29 | 3.03 |
| Roasted | treated | 2 | 5.36 | 2.97 | 3.5 |
| Ground | control | 1 | 5.39 | 6.71 | 4.49 |
| Ground | control | 2 | 3.94 | 6.62 | 4.31 |
| Ground | treated | 1 | 2.62 | 4.14 | 2.74 |
| Ground | treated | 2 | 2.42 | 3.65 | 2.45 |

TABLE 18
SAS results for color analysis on green coffee beans

| Control | | | | | | | |
|---|---|---|---|---|---|---|---|
| vs. | | | | | | | |
| Treated | | ANOVA | Mean | | | t grouping | |
| Variable | DF | SS | Square | F Value | Pr > F | Control | Treated |
| L* | 1 | 314.35 | 314.35 | 1624.98 | 6E−04 | A | B |
| a* | 1 | 25.20 | 25.20 | 309.4 | 0.0032 | A | B |
| b* | 1 | 18.23 | 18.23 | 684.16 | 0.0015 | A | B |

*means with the same t grouping letters are not significantly different

Table 18 shows the results of SAS analysis of the color of green coffee beans in terms of L*, a* and b* values (results shown in Table 17). ANOVA showed a significant difference between treated green beans and controls. This is also confirmed by the means which showed a good separation and grouping establishing a significant difference between samples.

After roasting, the coffee samples, did not have a significant color difference detectable by eye, showing that roasting was done consistently to both batches therefore achieving the same degree of roasting (FIGS. 20A and 20B). The images were analyzed again. The L*, a* and b* vales were calculated and analyzed by SAS for statistical differences using an Analysis of Variance (ANOVA) test.

TABLE 19
SAS results for color analysis on whole roasted coffee
beans

| Control | | | | | | | |
|---|---|---|---|---|---|---|---|
| vs. | | | | | | | |
| Treated | | | | | | | |
| Vari- | | ANOVA | Mean | | | t grouping | |
| able | DF | SS | Square | F Value | Pr > F | Control | Treated |
| L* | 1 | 10.49 | 10.49 | 40.11 | 0.024 | A | B |
| a* | 1 | 11.28 | 11.28 | 92.54 | 0.011 | A | B |
| b* | 1 | 17.72 | 17.72 | 319.64 | 0.0031 | A | B |

*means with the same t grouping letters are not significantly different

Table 19 shows the results of SAS analysis of the color of roasted whole coffee beans in terms of L*, a* and b* values. ANOVA showed a significant difference between treated roasted whole coffee beans and its controls. This is also confirmed by the means which showed a good separation and grouping establishing a significant difference between samples.

Average L*, a* and b* values of ground roasted coffee were measured for both treated and control samples. The results were analyzed by SAS for statistical differences.

Table 20 shows the results of SAS analysis of the color of green coffee beans in terms of L*(lightness), a*(redness) and b* (yellowness) values. An analysis of variance showed that there is no significant difference between treated roasted ground coffee beans and its controls in terms of the lightness; this was expected since grinding makes the overall color more uniform (FIGS. 21A and 21B). In terms of redness and yellowness a significant difference was found between the treated roasted and ground coffee beans and its controls. This is also confirmed by the means which showed a good separation and grouping establishing a significant difference between a* and b* values, but no differences in terms of the L* value.

TABLE 20
SAS results for color analysis on ground roasted
coffee beans

| Control | | | | | | | |
|---|---|---|---|---|---|---|---|
| vs. | | | | | | | |
| Treated | | | | | | | |
| Vari- | | ANOVA | Mean | | | *t grouping | |
| able | DF | SS | Square | F Value | Pr > F | Control | Treated |
| L* | 1 | 4.60 | 4.60 | 8.59 | 0.099 | A | B |
| a* | 1 | 7.67 | 7.67 | 123.66 | 0.0080 | A | B |
| b* | 1 | 3.29 | 3.29 | 111.86 | 0.0088 | A | B |

*means with the same t grouping letters are not significantly different

The average L*, a* and b* values of the three color standards present in each image with the samples, were also measured. The purpose of this was to make sure that these standards were analyzed consistently and accurately on every sample. It was found that these colors were the same for each replicate and also between controls and treated samples.

Visual and instrumental color analysis performed on the green, whole roasted and ground coffee beans, and its controls, showed that the acids and enzymes used affected the color of the treated beans. This was very clear visually and instrumentally from the green beans. For the whole roasted beans there was also a significant difference, although visually it was difficult to establish a difference between the treated and control samples. For the ground beans, the lightness value showed no significant difference between the treated and control samples, but the redness and yellowness was found to be significantly different, using machine vision. Color analysis figures are shown in FIGS. 19A-B, 20A-B, and 21A-B.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

### REFERENCES

Alasalvar, C., Odabasi, A. Z., Demir, N., Balaban, M. O., Shahidi, F., Cadwallader, K. R. 2004. Volatiles and flavor of five Turkish hazelnut varieties as evaluated by descriptive sensory analysis, electronicnose, and dynamic headspace analysis/gas chromatography-mass spectrometry. J. Food Sci. 69 (3): 99-106.
Davis, T. 2007. Ambex Roast true. Available at: www.ambexroasters.com, Accesed: February 2007.
Anzueto, F., Baumann, T. W., Graziosi, G., Piccin, C. R., Sondahl, M. R., Van der Vossen, H. A. M. 2005. The Plant. In: Illy and Vianni, eds. Espresso Coffee: The science of quality. 2^{nd} Edition. London. UK. Elsevier Academic Press. p. 2 1-86.
Balaban. M. O., Kristinsson, H. G., Otwell, S. W. 2005. Evaluation of color parameters in a machine vision analysis of carbon monoxide-treated fish-part 1: Fresh tuna. J. Aquatic Food Prod. Tech. 14 (2): 5-24
Balaban, M. O. 2007. Quantifying non-homogeneous colors in agricultural materials. Part 1. Method development. University of Florida. Gainesville, Fla.
Bee, S., Brando, C. H. J., Brumen, G., Carvalhaes, N., Kolling-Speer, I., Speer, K., Suggi Liverani, F., Texeira, A. A., Thomaziello, R. A., Viani, R., Vitzhum, O. G. 2005. The Raw Bean. In: Illy and Vianni, eds. Espresso Coffee: The science of quality. 2^{nd} Edition. London, UK. Elsevier Academic Press. p. 87-178.
Bicchi, C. P., Binello, A. E., Pellegrino, G. M., Vanni, A. C. 1995. Characterization of green and roasted coffees through the chlorogenic acid fraction by HPLC-UV and principal component analysis. J. Agric. Food Chem. 43: 1549-1555.
Bonnlander, B., Eggers, R., Engelhardt, U. H., Maier, H. G. 2005. The Raw Bean. In: Illy and Vianni, eds. Espresso Coffee: The science of quality. 2^{nd} Edition. London. UK. Elsevier Academic Press. p. 179-214.
Bradbury, A. G. W. 2001. Carbohydrates. In: R. J. Clarke and O. G. Vitzthum, eds. Coffee recent developments. Oxford: Blackwell Science. p. 1-17.
Czerny, M., Grosch, W. 2000. Potent odorants of raw arabica coffee. Their changes during roasting. J. Agric. Food Chem. 48: 868-872.
Czerny, M., Mayer, F., Grosch, W. 1999. Sensory study on the character impact odorants of roasted Arabica Coffee. J. Agric. Food Chem. 47: 695-699.
Charrier, A., Berthaud, J. 1985. Botanical classification of coffee. In: M. N. Clifford and K. C. Willson, eds. Coffee: botany., biochemistry, and production of beans and beverage. Westport, Conn.: The AVI Publishing Company, Inc. p. 13-47.
Clifford, M. N., Wright, J. 1976. Chlorogenic acids in coffee. J. Sci. Food. Agric. 27: 73.
Griffin, M. 2002a. Coffee Research Organization: Market. Available at: www.coffeeresearch.org/market/usa.htm. Accessed: May 2006.
Griffin, M. 2002b. Coffee Research Organization: Coffee drying. Available at: http://www.coffeeresearch.org/agriculture/drying.htm. Accessed: January 2007.
Griffin, M. 2002c. Coffee Research Organization: Coffee processing. Available at: http://www.coffeeresearch.org/agriculture/processing.htm. Accessed: January 2007.
Griffin, M. 2002d. Coffee Research Organization: Coffee roast color characteristics. Available at: http://www.coffeeresearch.org/coffee/roast.htm. Accessed: January 2007.
Griffin, M. 2002e. Coffee Research Organization: Coffee roasting. Available at: http://www.coffeeresearch.org/coffee/roasting.htm. Accessed: January 2007.
Griffin, M. 2002f. Coffee Research Organization: Coffee cupping. Available at: http://www.coffeeresearch.org/coffee/cupping/htm. Accessed: January 2007.
Damar, S. 2006. Processing of coconut water with high pressure carbon dioxide technology. [DPhil dissertation]. Gainesville, Fla.: University of Florida. Available from: University of Florida Library.
Dark, S. K., Nursten, H. E. 1985. Volatile components. In: Clarke R J, Macrae R, editors. Coffee Chemistry. New York: Elsevier Applied Science Publishers. 1. p. 223-265.
Flament, I. 2001. The volatile compounds identified in green coffee beans. In: Coffee flavor chemistry. Chichester: J. Wiley and Sons. p. 29-34.
Corporate Document Repository Staff. 2003. FAO. Medium term prospects for agricultural commodities. Rome. p. 67. Available at: ftp://ftp.fao.org/docrep/fao/006/y5143e/y5143e00.pdf. Accessed: January 2007.
Statistics Dividion Staff. 2007. FAO. Economic and social department. Available at: http://www.fao.org/es/ess/toptrade/trade.asp?lang=EN&country=231. Accessed: January 2007.
Franca, A. S., Mendonca, J. C. F., Oliveira, S. D. 2005. Composition of green and roasted coffees of different cup qualities. Lwt-Food Sci and Tech. 38 (7):709-15.
Ginz, M. 2001. Bittere diketopiperarine und chlorogensaudererivate in rostkaffee. Thesis. TU Braunschweig, Germany.
Zhang, H., Balaban. M. O., Principe, J. C., Portier, K. 2005. Quantification of spice mixture compositions by electronic nose: Part 1. Experimental design and data analysis using neural networks. J. Food Sci. 70 (4):253-258,
Holscher, W. Vitzthum, O., Steinhart, H. 1990. Identification and sensorial evaluation of aroma impact compounds in roasted coffee. Proc. 14^{th} ASIC Coll. p. 130-136.
Homma, S. 2001. Non-volatile compounds, Part II. In: R. J. Clarke and O. G. Vitzthum, eds. Coffee—Recent developments. Oxford: Blackwell Science. p. 50-67.
International Coffee Organization “ICO”. 2002. Annual statistics on coffee production and international trade. London.
International Trade Centre “ITC”. 2002. Coffee, and exporter's guide. Product and marketing development. UNCTAD CNUCFD, WTO OMC. Geneva.
Kurt, A., Speer, K. 2002. Unteruchungen zum Einfluss der Dampfungsparameter auf die Diterpengehalte von Arabica Roh und Rostkaffees. Dtsch. Lebensm. Rdsch. 98: 1-4.
Korel, F., Luzuriaga, D. A., Balaban, M. O. 2001. Objective quality assessment of raw tilapia (Oreochromis niloticus) fillets using electronic nose and machine vision. J. Food Sci. 66 (7): 1018-1024.
Korel, F., Balaban, M. O. 2002a. Microbial and sensory assessment of milk with an electronic nose. J. Food Sci. 67 (2):758-764.
Korel, F. Balaban, M. O. 2002b. Uses of electronic nose in the food industry. Gida (Turkish). 28 (5): 505-511.
Lawless, H. T. Heymann. H. 1998. Sensory evaluation of food: Principles and practices. Chapman and Hall. NY. p. 819.
Lee, K., Shibamoto, T. 2002. Analysis of volatile components isolated from hawaiian green coffee beans (Coffea Arabica L.). Flavour Fragr. J. 17: 349-351.
Lisinska, G., Golubowska, G. 2004. Structural changes of potato tissue during french fries production. J. Food Chem. 93: 68 1-687.
Luzuriaga, D. A. 1999. Application of computer vision and electronic nose technologies for quality assessment of color and odor of shrimp and salmon [DPhil dissertation]. Gainesville, Fla.: University of Florida. Available from: University of Florida Library.
Luzuriaga, D. A., Balaban, M. O., Yerelan, S. 1997. Analysis of visual quality attributes of white shrimp by machine vision. J. Food Sci. 62: 113-8.
Macrae, R. 1985. Nitrogenous compounds. In: R. J. Clarke and R. Macrae, eds. Coffee: Volume 1—Chemistry. Barking: Elsevier Applied Science. p. 115-152.
Marcone, N. F. 2004. Composition and properties of indonesian palm civet coffee (Kopi Luwak) and ethiopian civet coffee. Food Res. Int. 37 (9): 901-9 12.
Martinez, L. F. Balaban, M. O. 2006. Effect of temperature on the translucency of tilapia muscle. Presented in the Institute of Food Technology Annual Meeting. Orlando, Fla. August 2006.
Martinez, L. F., Ochsenius, M. E., Balaban, M. O., Schmidt R. 2007a. Effect of high pressure processing in raw milk. Presented in the Institute of Food Technology Annual Meeting. Chicago, Ill. August 2007.
Martinez, L. F., Cevallos, J. M., Balaban, M. O., Kristinsson, H. 2007b. Effect of carbon monoxide and ozone in the bloodline color of yellowfin tuna. Presented in the Institute of Food Technology Annual Meeting. Chicago, Ill. August 2007.
Mayer, F., Grosch, W. 2002. Aroma simulation on the basis of the odorant composition of roasted coffee headspace. Flavour Fragr. J. 16: 180-190.
Moores, R. G., McDermott. D., Wood, T. R. 1948. Determination of chlorogenic Acid in Coffee. Central Laboratories, General Foods Corporation. Hoboken N.J.
Oliveira, A. C. M., Crapo, C. A., Himelbloom, B., Vorholt, C., Hoffert, J. 2005. Headspace gas chromatography-mass spectrometry and electronic nose analysis of volatile compounds in canned Alaska pink salmon having various grades of watermarking. J. Food Sci. 70: 419-26.
Pearson, D. 1976. The chemical analysis of foods. 7^{th} Edition. London. Churchill Livingstone. p. 438.
Petracco, M. 2005. The Plant. In: Illy and Vianni, eds. Espresso Coffee: The science of quality. Second Edition. London, UK. Elsevier Academic Press. p. 2 16-229.
Redgwell, R. J., Trovato, V., Curti, D., Fisher, M. 2002. Effect of roasting on degradation and structural features of polysaccharides in arabica coffee beans. Carbohydrate Research. 337: 421-431.
Rigitano, A., Sousa, O. F., Fava, J. F. M. 1963. Coffee processing. In: C. A. Krug, ed, Agricultural practices and fertilization of coffee. Instituto Brasilero Potassa. Sao Paulo. p. 2 15-259.
Schenker, S., Heinemann, C., Huber, M., Pompizzi, R., Perren, R. Escher, F. 2002. Impact of roasting conditions on the formation of aroma compounds in coffee. J. Food Sci. 67: 60-66.
Sims, C. 2004. Sensory Analysis handouts. Quality Control Class. University of Florida. Gainesville, Fla.
Smith, R. F. 1985. History of coffee. In: M. N. Clifford and K. C. Willson, eds. Coffee: botany, biochemistry, and production of beans and beverage. Westport, Conn.: The AVI Publishing Company, Inc. p. 1-12.
Specialty Coffee Association of America “SCAA”. 2002. The art of aroma perception in coffee. Poster.
Speer, K., Kolling-Speer, I. 2001. Lipids. In: R. J. Clarke and O. G. Vitzthum, eds. Coffee—recent developments. Oxford: Blackwell Science. p. 33-49.
Stadler, R., Varga. N., Hat, J., Vera, F., Welti, D. 2002. Alkylpyridiniums. 1. Formation in model systems via thermal degradation of trigonelline. J. Agric. Food Chem. 50:1192-1199.
Stetter, J. R. 2006. Illinois Institute of Technology. Chicago Ill. Available at: http://www.iit.edu/˜jrsteach/enose.html. Accessed: February 2007.
Summa Coffea Academy™. 2007. Cupping & Sensory Evaluation. Clearwater, Fla.
Tambe. Y. 2007. Wikipedia encyclopedia: Sensory analysis. Available at: http://en.wikipedia.org/wiki/Sensory_analysis. Accessed: February 2007.
Teixeira, A. A. 1978. Estudo preliminar sobre a qualidade do café no estado de Sao Paulo safra 78/79. 6to Congresso Braileiro de pesquisas cafeeiras. Ribeirao Preto, SP. p. 316-322.
Tosello, A. 1946. Studies on the drying of agricultural products. Bragantia p. 39-107.
Trugo, L. C., Macrae, R. 1984. A study of the effect of roasting on the cholorogenic acid composition of coffee using HPLC. Food Chem. 15: 2 19-227.
USDA, Foreign Agricultural Service. 2003. Coffee Update world coffee production 2003/2004. Available at: http://www.fas.usda.gov/htp/tropical/2003/06-03/June%202003%20Text.pdf.
Van Deventer, D., Mallikarjunan, P. 2002. Comparative performance analysis of three electronic nose systems using different sensor technologies in odor analysis of retained solvents on printed packaging. J. Food Sci. 67 (80):3 170-83.
Vincent, J. C. 1987. Internacional standarization. In: R. J. Clarke and R. Macrae, eds. Coffee: Volume 1-technology. London: Elsevier Applied science. p. 28-30.
Wikipedia contributors. 2006. Wikipedia Encyclopedia: Processing of coffee. Available at: http://en.wikipedia.org/wiki/Procesing_of_coffee. Accessed: May 2006.
Wrigley, G. 1988. Coffee. Longman Scientific Technical and John Wiley & Sons, Inc. New York. p. 639.
Wurziger, J., Harms, U. 1969. Beitrage zum genubwert und zur bekommlichkeit rostkaffees. Kaffe und Tee Markt. 19 (18): 26-29.
Wurziger, J. 1972. Carbosaurehydroxytrpyptamide oder atgerlosliche extraktstoffe zum nachweis und zur beurteilung von bearbeiteten bekommliclien rostkaffees. Kaffe und Tee Markt 22 (14): 3-11.
Yeretzian, C., Jordan, A., Badoud, R., Lindinger, W. 2002. From the green bean to the cup of coffee: investigating coffee roasting by on-line monitoring of volatiles. Eur. Food Res. Technol. 214: 92-104.
Yoruk, R., Yoruk, S., Balaban, M. O., Marshall, M. R. 2004. Machine vision analysis of antibrowning potency for oxalic acid: A comparative investigation on banana and apple. J. Food Sci. 69: 28 1-289.

We claim:

1. A method for improving the quality of coffee beans wherein the method comprises contacting coffee beans with an acidic solution ex vivo for a period of time between about 90 minutes to about 24 hours, and wherein said acidic solution comprises an enzyme.

2. The method according to claim 1, wherein the coffee beans are green coffee beans.

3. The method according to claim 1, wherein said acidic solution has a pH between 1 to 5.

4. The method according to claim 3, wherein the pH is between 1.5 to 2.

5. The method according to claim 1, wherein the enzyme is selected from the group consisting of: amylases, glucosidases, mannosidases, dextranases, proteases, exoproteases, endoproteases, phosphatases, phytases, phospholipases, lipases and nucleases.

6. The method according to claim 1, wherein the enzyme is pepsin.

7. The method according to claim 6, wherein the pepsin is porcine pepsin.

8. The method according to claim 1, wherein the solution comprises about 8.0×10³ to about 13×10³ units of pepsin per kg of coffee beans.

9. The method according to claim 1, wherein the coffee beans are contacted with the solution for between about 10 hours and about 14 hours.

10. The method according to claim 1, wherein the coffee beans are de-pulped before being contacted with the solution.

11. The method according to claim 1, wherein the coffee beans are dried before being contacted with the solution.

12. The method according to claim 1, further comprising the step of drying the coffee beans after the beans have been contacted with the solution.

13. The method according to claim 1, further comprising the step of roasting the coffee beans after the beans have been contacted with the solution.

14. The method according to claim 1, wherein the coffee beans comprise an external mucilage and the external mucilage is removed prior to subjecting the beans to the solution.

15. A coffee product comprising coffee beans that have been contacted ex vivo with an acidic solution for a period of time between about 90 minutes to about 24 hours, wherein said acidic solution comprises an enzyme.

16. The coffee product according to claim 15, wherein the coffee beans have been subjected to an acidic solution having a pH between 1.5 and 2.

17. The coffee product according to claim 15, wherein the coffee beans have been subjected to an acidic solution comprising an enzyme selected from the group consisting of: amylases, glucosidases, mannosidases, dextranases, proteases, exoproteases, endoproteases, phosphatases, phytases, phospholipases, lipases and nucleases.

18. The coffee product according to claim 15, wherein the enzyme is pepsin.

19. The coffee product according to claim 18, wherein the pepsin is porcine pepsin.

20. The coffee product according to claim 15, wherein the coffee beans have been contacted with the solution for between about 10 hours and about 14 hours.

21. The coffee product according to claim 15, wherein the coffee beans have been roasted following being contacted with the acidic solution.

22. The coffee product according to claim 21, wherein the coffee beans have been ground following roasting.
